(19) United States
(12) Patent Application Publication
(10) Pub. No.: US 2026/0036981 A1
(43) Pub. Date: Feb. 5, 2026

(54) TARGET POSITIONING DEVICE FOR AUTONOMOUS SYSTEMS

(71) Applicant: Rugged Robotics Inc., Houston, TX (US)

(72) Inventors: Juan Cabral, Houston, TX (US); Jack Sampson, Katy, TX (US); Paul Valle, Houston, TX (US); Kevin Chen, Austin, TX (US); Logan Farrell, Houston, TX (US); Derrick Morse, Houston, TX (US)

(73) Assignee: Rugged Robotics Inc., Houston, TX (US)

(21) Appl. No.: 19/287,043

(22) Filed: Jul. 31, 2025

Related U.S. Application Data
(60) Provisional application No. 63/678,413, filed on Aug. 1, 2024.

(51) Int. Cl. G05D 1/242; G05D 1/244; G05D 107/90; G05D 111/10

(52) U.S. Cl. CPC G05D 1/242; G05D 1/244; G05D 2107/90; G05D 2111/17

(57) ABSTRACT

Described herein are embodiments of a positioning device for positioning a target in an environment for use by a system in localization in the environment. The positioning device comprises a base, a rod extending along a longitudinal axis of the base, an alignment spike attached to a first end of the rod, and at least three legs connected to the base. The alignment spike comprises a tip for contacting a point on a surface that the positioning device is placed upon. Each of the legs is configured to extend radially from the base and retract radially towards the base.

### CROSS-REFERENCE TO RELATED APPLICATIONS

This application claims priority to and the benefit under 35 U.S.C. § 119 (e) of U.S. Provisional Patent Application Ser. No. 63/678,413, filed on Aug. 1, 2024, entitled “TARGET POSITIONING DEVICE FOR AUTONOMOUS SYSTEMS,” which is incorporated herein by reference in its entirety.

### FIELD

Disclosed embodiments are related to a positioning device for positioning a target in a site. For example, the positioning device may be used to position a passive landmark in a worksite for use by a mobility platform or by a stationary platform in localization in the site.

### BACKGROUND

Some autonomous or semi-autonomous systems that perform area coverage tasks employ beaconed navigation systems. Such navigation systems may require the placement of powered navigational equipment external to the autonomous or semi-autonomous system in known locations in a worksite. Alternatively, some systems may use external position determination sensors, such as a global navigation satellite system (GNSS) (e.g., a global positioning system (GPS)).

### SUMMARY

In some aspects, the techniques described herein relate to a positioning device for positioning a target in an environment for use by a system for localization in the environment. The positioning device comprises: a base; a rod extending along a longitudinal axis of the base; an alignment spike attached to a first end of the rod, the alignment spike comprising a tip for contacting a point on a surface that the positioning device is placed upon; and at least three legs hingedly connected to the base, each of the at least three legs configured to: extend radially from the base; and retract radially towards the base.

In some aspects, the techniques described herein relate to a system for navigation of a mobility platform in a worksite. The system comprises: a plurality of passive landmarks placed at a plurality of locations in the worksite for use by the mobility platform in navigating throughout the worksite. Each of at least some of the plurality of passive landmarks placed using a positioning device comprises a base; a rod extending along a longitudinal axis of the base; an alignment spike attached to a first end of the rod, the alignment spike comprising a tip for contacting a point on a surface that the positioning device is placed upon; and at least three legs hingedly connected to the base, each of the at least three legs configured to: extend radially from the base; and retract radially towards the base.

In some aspects, the techniques described herein relate to a system for navigation of a mobility platform in a worksite. The system comprises: a plurality of passive landmarks placed at a plurality of locations in the worksite for use by the mobility platform in navigating throughout the worksite, each of at least some of the plurality of passive landmarks placed using a positioning device. The positioning device comprises: a base; a rod extending along a longitudinal axis of the base; an alignment spike attached to a first end of the rod, the alignment spike comprising a tip for contacting a point on a surface that the positioning device is placed upon; and at least three legs hingedly connected to the base, each of the at least three legs configured to: extend radially from the base; and retract radially towards the base.

In some aspects, the techniques described herein relate to a positioning device for positioning a target in an environment for use by an autonomous system in navigating throughout the environment. The positioning device comprises: a base comprising a target engagement portion; a rod extending along a longitudinal axis of the base; an alignment spike attached to a first end of the rod, the alignment spike comprising a tip for contacting a point on a surface that the positioning device is placed upon; and at least three legs each hingedly attached to the base, the at least three legs extended radially from the base.

In some aspects, the techniques described herein relate to a positioning device for positioning a target in an environment for use by an autonomous system in navigating throughout the environment. The positioning device comprises: a base comprising: a target engagement portion; and a recessed portion; a rod extending along a longitudinal axis of the base; an alignment spike attached to a first end of the rod, the alignment spike comprising a tip for contacting a point on a surface that the positioning device is placed upon; and at least three legs hingedly mounted to an under surface of the base, the at least three legs fully stowed in the recessed portion of the base.

In some aspects, the techniques described herein relate to a positioning device for positioning a target in an environment for use by an autonomous system in navigating throughout the environment. The positioning device comprises: a cylindrical base, the cylindrical base comprises: a flange; and a central portion attached to the flang; a rod extending along a longitudinal axis of the base; an alignment spike attached to a first end of the rod, the alignment spike comprising a tip for contacting a point on a surface that the positioning device is placed upon; and at least three legs hingedly mounted to the flange of the cylindrical base.

In some aspects, the techniques described herein relate to a method of placing a plurality of landmarks in a worksite for use by a mobility platform in navigating in the worksite. The method comprises: for each of a plurality of positioning devices, placing the positioning device at a location in the worksite with an alignment spike of the positioning device contacting a point on a surface on which the positioning device is placed; configuring a rotational position of one or more retractable legs of the positioning device; placing a landmark on the positioning device.

The foregoing summary is non-limiting.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic of an exemplary embodiment of a construction assistance system with a mobility platform for navigation in a worksite;

FIG. 2 is a top schematic view of an exemplary embodiment of a mobility platform chassis in a first state;

FIG. 3 is a top schematic view of the mobility platform of FIG. 2 in a second state;

FIG. 4 is a top schematic view of the mobility platform of FIG. 2 in a third state;

FIG. 5 is a perspective view of an exemplary embodiment of a mobility platform;

FIG. 6 is a side view of the mobility platform of FIG. 5.

FIG. 7 is a side schematic of an exemplary embodiment of a laser rangefinder of a mobility platform in a first position;

FIG. 8 is a side schematic of the laser rangefinder of FIG. 8 in a second orientation;

FIG. 9 is a side schematic of the laser rangefinder of FIG. 8 in a third orientation;

FIG. 10 is a top schematic view of an exemplary embodiment of a mobility platform and a plurality of passive landmarks;

FIG. 11 is a top schematic view of an exemplary embodiment of a mobility platform and a plurality of passive landmarks;

FIG. 12A is a schematic of an exemplary embodiment of a mobility platform employing a laser rangefinder to determine a position of the laser rangefinder relative to a passive landmark;

FIG. 12B is a graph of distance measurements versus yaw angle of the laser rangefinder of FIG. 12A;

FIG. 13A is a schematic of another exemplary embodiment of a mobility platform employing a laser rangefinder to determine a position of the laser rangefinder relative to a passive landmark;

FIG. 13B is a graph of distance measurements versus yaw angle of the laser rangefinder of FIG. 13A;

FIG. 14A is a schematic of another exemplary embodiment of a mobility platform employing a laser rangefinder to determine a position of the laser rangefinder relative to a passive landmark;

FIG. 14B is a graph of distance measurements versus yaw angle of the laser rangefinder of FIG. 14A;

FIG. 15 is a flow chart of an exemplary method of operating a mobility platform;

FIG. 16 is a flow chart of an exemplary method of operating a mobility platform;

FIG. 17 is a perspective view of an exemplary embodiment of a passive landmark;

FIG. 18A is an example of an image of a passive landmark captured by a camera of a mobility platform;

FIG. 18B is an example of the image of FIG. 18A processed to a binary image;

FIG. 18C is an example of the image of FIG. 18B with the passive landmark identified by computer vision;

FIG. 19A is an example of an image of a passive landmark captured by a camera of a mobility platform;

FIG. 19B is an example of the image of a passive landmark of FIG. 19A captured by the camera employing an embodiment of a hood;

FIG. 19C is an example of the image of FIG. 19B processed to a binary image;

FIG. 20 is a block diagram for an exemplary embodiment of a method of operating a mobility platform;

FIG. 21 is a top schematic view of an exemplary embodiment of a mobility platform in a first position, a worksite, and a plurality of passive landmarks; and

FIG. 22 is a top schematic view the mobility platform, worksite, and plurality of passive landmarks of FIG. 21 with the mobility platform in a second position.

FIG. 23A is a perspective view of a positioning device;

FIG. 23B is another view of the positioning device of FIG. 23A;

FIG. 24A is a perspective view of a positioning device in a stowed position;

FIG. 24B is another view of the positioning device in FIG. 24A;

FIG. 25A is a perspective view of a positioning device engaged with a target;

FIG. 25B is another view of the positioning device of FIG. 25A engaged with the target;

FIG. 25C is an exploded view illustrating how the target engages with the positioning device;

FIG. 26A is a perspective view of a positioning device in a stowed position and engaged with a target;

FIG. 26B is another view of the positioning device of FIG. 26A;

FIG. 27 is a perspective view of a positioning device with caps placed on its legs;

FIG. 28 is a perspective view of a positioning device in a stowed position with caps on its legs; and

FIG. 29 is a flowchart of an example method for placing targets in an environment using positioning devices.

### DETAILED DESCRIPTION

The inventors have appreciated that certain situations require the deployment of several (e.g., between 10-100) targets throughout an environment. For example, the targets may be used by an autonomous system (e.g., an autonomous vehicle) for navigating around an environment. As another example, the targets may be used by a surveyor to determine the position of a total station in an environment. In these situations, setting up the environment requires time to place targets at locations throughout the environment. Deploying targets in an environment involves positioning them accurately at specific locations throughout the environment and ensuring that the targets remain stable at those locations. Thus, the inventors have recognized that a positioning system that allows efficient target deployment reduces the amount of time required to configure an environment (e.g., for measurement by a surveyor and/or navigation of an autonomous system). Moreover, the inventors recognize the importance of the targets remaining stable at their locations to allow for accurate measurements based on the target.

Accordingly, the inventors have developed a target positioning device (also referred to as “positioning device”) that improves the efficiency with which targets can be placed in an environment. The positioning device is smaller and more compact than conventional surveyors that may be used to place targets. The positioning device includes an alignment spike that allows for precise placement of a target at a location in an environment (e.g., by aligning the landmark with a point in the environment). The alignment spike may be designed such that its point contacts a point on the ground when the positioning device is placed at a location. The alignment spike allows targets to be deployed at locations throughout an environment with improved accuracy relative to conventional techniques of deploying targets. The positioning device further includes a base with multiple legs (e.g., a tripod base) that support a target placed on top of the base. The positioning device allows targets to remain stable and thus ensure accurate measurements using the targets (e.g., by a surveyor and/or an autonomous system).

Given that targets often need to be moved to place them in an environment and/or remove them from the environment, the inventors have developed a positioning device that is lightweight and compact. Example dimensions and weights of a positioning device and a target are described herein. This makes the positioning device easy to move. The compactness of the positioning device minimizes the space in a site required by the positioning device. The positioning device can also be stowed, providing flexibility in how much space the positioning device takes up. The positioning device includes legs that can be folded into a base of the positioning device. The positioning device may be placed with the legs stowed (e.g., if the legs are not needed to stabilize the positioning device) or with the legs extended from the base of the positioning device. The alignment spike may further be pushed into the base when stowed. These features provide flexibility in stowing and storing the positioning device, and in how the positioning device is deployed (e.g., with or without its legs extended).

Some embodiments provide positioning device for positioning a target (e.g., a cylindrical target or a prism target) in an environment for use by a system for localization in the environment. The positioning device comprises: a base (e.g., a cylindrical base); a rod extending along a longitudinal axis of the base; an alignment spike attached to a first end of the rod, the alignment spike comprising a tip for contacting a point on a surface that the positioning device is placed upon; and at least three legs hingedly connected to the base, each of the at least three legs configured to: extend radially from the base; and retract radially towards the base.

In some embodiments, the rod has a passive vertical degree of freedom along the longitudinal axis of the base. In some embodiments, the position of the foot relative to the leg is adjustable independently of positions of other feet relative to other legs.

In some embodiments, the target may weigh less than 25 oz. For example, the target may be approximately 22 oz. In some embodiments, the base may be less than 30 oz. For example, the base may be approximately 25.5 oz. In some embodiments, the combined weight of the target and base may be less than 50 oz. For example, the combined weight of the target and weight may be approximately 47.5 oz. The positioning device is also compact making it easy to store and move.

In some embodiments, the base may be cylindrical and have a diameter of less than 10 inches (in.). with its legs extended. For example, the base may have a diameter of approximately 9 in. with its legs extended. In some embodiments, the base in its stowed position may have a diameter between 1 in. and 6 in. For example, the base in its stowed position (i.e., with its legs retracted) may have a diameter of approximately 4.5 in.

In some embodiments, the target may be a cylindrical target with a diameter of less than 5 in. For example, the target may have a diameter of approximately 4.5 in. In some embodiments, the height of the target may be less than 15 in. For example, the height of the target may be approximately 12 in.

A target may need to be positioned in various different types of environments. Some environments may have a surface of variable height onto which a target needs to be placed. Thus, the target may need to placed at point where there is height variability in an arca surrounding the point where the target is to be placed. Despite the variability in height around a point at which the target needs to be placed, the target may need to remain stable in a particular position. Accordingly, the inventors have developed a positioning device that can position a target accurately in different environments. The positioning device includes adjustable components that allow the positioning device to accurately position a target despite variation in height. The positioning device base has legs with feet, where the height of each foot can be adjusted independently of the height of other feet. These allow the positioning device to be adjusted to a desired position of a target (e.g., by adjusting height of the feet to control pitch and roll of the positioning device). For example, one foot may be elevated relative to another foot in order to provide a level surface on which a target is placed.

One example system for which a positioning device may be used is a system using a mobility platform to autonomously position a tool within a worksite (e.g., to increase construction productivity). In particular, the mobility platform may be configured to navigate throughout the worksite using landmarks placed throughout the worksite as targets that are identifiable by the mobility platform. Such passive landmarks may lack communication equipment, such that the landmarks are inexpensive and easy to place and configure for an end user. A positioning device may be used to position the landmarks in the worksite. A mobility platform may navigate by monitoring its position relative to the placed passive landmarks, as discussed further herein. A mobility platform according to exemplary embodiments herein may include a marking device such that layouts may be marked on a worksite floor with high precision and accuracy.

Although some example embodiments of a positioning device may be described herein in the context of an autonomous system (e.g., a mobility platform), it should be appreciated that the positioning device is not restricted to such an application. The positioning device may be used to place targets in an environment for any suitable situation. For example, the positioning device may be used to place targets in an environment to facilitate use of a total station by a surveyor. The surveyor may walk to multiple locations in an environment (e.g., a construction site) to determine the position of a total station. Any movement of the total station may require the surveyor to walk to the locations again. The positioning device may be used to place stationary targets in the environment at the locations such that the surveyor need not walk to the different locations every time the total station is moved.

A target may be any suitable object for using in localization (e.g., by a mobility or stationary platform). In some embodiments, the target may be a particular geometric shape. For example, the target may be a cylinder, a prism, a cube, a cone, a sphere, a tetrahedron, a square pyramid, a pentagonal pyramid, an octahedron, a dodecahedron, or another suitable shape. In some embodiments, a target may have a surface with certain properties that allow the target to be used in localization. For example, the target may have a reflective surface with a threshold level of reflectivity (e.g., the target may have a reflection coefficient greater than 0.7).

### Example Systems For Use of Positioning Device

A mobility platform may employ a laser rangefinder configured to measure single point distance to a passive landmark placed at a known landmark positioned in a worksite. The laser rangefinder may obtain a precise distance measurement between the mobility platform and the passive landmark which may be used to localize the mobility platform in the worksite. A mobility platform may sweep the laser rangefinder across the passive landmark to obtain a plurality of single point distance measurements for a plurality of yaw angles of the laser rangefinder. The plurality of single point distance measurements may be fit to a known shape of the passive landmark, such that the geometric center (or other point of interest) of the passive landmark may be obtained. The geometric center or other point of interest may correspond to a control point in the worksite, and the relative distance between the geometric center of the passive landmark measured may be employed to determine a precise location of the mobility platform in the worksite as discussed further with reference to embodiments herein. The passive landmarks may have predetermined shapes that are recognizable for fitting to the plurality of measured points. For example, cylindrical landmarks may be employed such that a plurality of measured points generally arranged in an arc in the two-dimensional plan of the worksite may be fit to the known size and circular plan shape of the cylindrical landmark.

Once a mobility platform is localized within a worksite (for example, by shape recognition of passive landmarks through distance measurements), a laser rangefinder may be employed to locate and add other landmarks or structures to a worksite plan. For example, a laser rangefinder may sweep the entire worksite or a portion of the worksite and collect a plurality of distance measurements. Any distance measurements corresponding to structures or other landmarks not already a part of the plan of the worksite may be added to the plan based on the relative distance measurements from the localized mobility platform. In this manner, any unknown structure within the worksite may be placed into a worksite plan. In some embodiments, a revised worksite plan or the measured distance information may be uploaded to a remote server.

A sensor system for a mobility platform may determine distance measurements for passive landmarks. A laser rangefinder may be oriented toward a passive landmark in a worksite and perform a sweep to collect a plurality of distance measurements associated with a plurality of yaw angles of the laser rangefinder. A secondary system may be used to assist in acquiring passive landmarks to allow a sweep angle of a laser rangefinder to be smaller than it may otherwise be thereby improving the speed of localization. The sensor system may allow a laser rangefinder to track and maintain distance measurement to a passive landmark while a mobility platform is moving.

In some embodiments, a sensor system may employ a camera that allows for computer vision based detection of one or more passive landmarks in a worksite. The one or more passive landmarks may be detected by processing an image of from the camera such that a yaw angle of a laser rangefinder may be adjusted to target the passive landmark. In some embodiments, a rangefinder axis may be disposed within a field of view of the camera, such that the camera may be employed by a mobility platform as a sight for the laser rangefinder. In some embodiments, the camera and the laser rangefinder may be disposed on the same housing and may be configured to be moved in a yaw direction together by a yaw actuator. In some embodiments, the sensor system may employ an infrared light source configured to illuminate a passive landmark. In some such embodiments, a passive landmark may include one or more reflective surfaces, which may form a distinct pattern in an image captured by the camera. For example, the reflective surfaces may have a reflectivity, size, and/or relative spacing that may form the basis for one or more thresholds to detect the passive landmark in an image. In this manner, a passive landmark may be reliably detected in an image captured by the camera, and a laser rangefinder may be oriented toward the passive landmark to measure a distance to the passive landmark and/or perform a sweep as described with reference to other embodiments herein.

In some cases, a mobility platform may be operated in outdoor environments. Accordingly, in some circumstances light from the sun or other sources may interference with images captured by a camera of a sensor system of a mobility platform. Some embodiments use a hood for a camera of a sensor system which obstructs a portion of a field of view of the camera. For example, the hood may obstruct an upper portion of the field of view of the camera so that image information captured by the camera does not include artifacts or glare caused by the sun. Additionally, the hood may narrow a light beam angle of an infrared light source of the sensor system so that the illumination is directed towards passive landmarks and not other surfaces that may be in the field of view of the camera. Such an arrangement may reduce false positives of passive landmark detection in an image.

In some embodiments, a mobility platform may employ multiple sensors which are used to determine comparable positioned within a worksite. A mobility platform may employ laser rangefinders to determine a highly accurate and precise location of the mobility platform for performing one or more tasks in the worksite at one or more task locations. In some embodiments, the mobility platform may include a first laser rangefinder and a second laser rangefinder. The first laser rangefinder and the second laser rangefinder may be configured to collect distance information between each respective rangefinder and a passive landmark disposed in the workspace. In some embodiments, the distance information from the first laser rangefinder and the second laser rangefinder may be provided to at least one processor of the mobility platform (e.g., a controller). The first laser rangefinder may be disposed at a first location on a chassis of the mobility platform. The second laser rangefinder may be disposed at a second location on the chassis of the mobility platform, where the first location and second location are different from one another. The mobility platform may be configured to determine a first distance between a passive landmark and the first location based on the distance information from the first laser rangefinder and a second distance between a passive landmark and the second location based on the distance information from the second laser rangefinder. Using the first distance and the second distance, the mobility platform may determine an orientation of the chassis in the plane of the worksite.

In some embodiments, a mobility platform may acquire a passive landmark with a laser rangefinder to obtain useful distance information from the laser rangefinder. In some embodiments, acquiring a passive landmark refers to a method of orienting a laser rangefinder toward a passive landmark such that an accurate distance measurement may be taken by the laser rangefinder relative to the passive landmark. In some embodiments, the laser rangefinder may emit an infrared and/or visual light toward a passive landmark (e.g., a laser). The light emitted toward the passive landmark may be reflected back to the laser rangefinder. The rangefinder may determine a distance to the passive landmark based on a phase shift of the light emitted toward the passive landmark. Accordingly, the distance determination is based on the accurate targeting of the passive landmark such that the passive landmark reflects the light and not another object in the worksite. In some embodiments, the mobility platform may be configured to sweep a worksite with a laser rangefinder to collect sweep information. As used herein a “sweep” may be an angular movement of the laser rangefinder within a plane of the worksite across an angular range in a yaw direction. In some embodiments, the angular range may be 15 degrees, 30 degrees, 45 degrees, 90 degrees, 180 degrees, 270 degrees, 360 degrees, or another appropriate angle. The sweep information may include a plurality of distances measured across the angular range. In some embodiments, the mobility system may acquire a passive landmark by detecting a shape of the landmark in the sweep information, for example, by fitting a predetermined shape to the distance measurements. For example, in some embodiments a passive landmark may be cylindrical, and the sweep information may include distance measurements that in series correspond to the shape of the cylindrical passive landmark. As another example, in some embodiments passive landmark may have the shape of a rectangular prism, which may be similarly detectable based on serial distance measurements within the sweep information. In other embodiments any shape for a passive landmark may be employed, as the present disclosure is not so limited.

In some embodiments, the mobility platform may include a holonomic drive system for a platform that navigates a worksite. The holonomic drive system may allow the mobility platform to move in three degrees of freedom (e.g., translation within a plane and rotation within the plane) so that a tool mounted on the mobility platform may reach the extremities of a worksite to perform one or more tasks. In some embodiments, the holonomic drive may allow the mobility platform to move omnidirectionally in the three degrees of freedom. In one embodiment, the holonomic drive system includes four wheels which are independently actuatable and independently swivel to allow the mobility platform to translate in a plane, rotate about a central axis, or a combination of the two (e.g., three degrees of freedom). In some embodiments, a drive system of a mobility platform may include four wheel assemblies, wherein each of the four wheel assemblies includes a wheel configured to rotate about a wheel axis, a first actuator (e.g., a first motor) configured to rotate the wheel about the wheel axis, and a second actuator (e.g., a second motor) configured to rotate the wheel about a pivot axis perpendicular to the wheel axis. The first actuator and second actuator may be independently controllable to allow the wheel assembly to move the mobility platform in any of the three degrees of freedom when correspondingly operated with other wheel assemblies. In other embodiments, more than four wheel assemblies or less than four wheel assemblies may be employed, as the present disclosure is not so limited. In some embodiments, each wheel of the mobility platform may include a wheel odometer configured to measure a distance traveled by the wheel. In some embodiments, the wheel odometer may be a rotary encoder. In another embodiments, the wheel odometry may be based on use of a stepper motor for driving the wheel, where the stepper motor rotational position and change in position are determinable. In some embodiments, a wheel assembly may also include a swivel sensor (e.g., rotary encoder, potentiometer, stepper motor, etc.) configured to provide information regarding the rotation of the wheel about the pivot axis. Combined, the swivel sensor and wheel odometer may provide information allowing the position and orientation of the wheel to be estimated as the mobility platform moves throughout a worksite. Correspondingly, a position and orientation of the mobility platform itself may be estimated based on information from the swivel sensor and the wheel odometer.

As used herein, a control point or control line may be a point marked in a worksite (e.g., on a floor of a worksite) and used conventionally by surveyors as a known point for relative measurements between other items to be placed or constructed in the worksite. In some embodiments, passive landmarks may be configured to be placed on control points or control lines. According to exemplary embodiments herein, a mobility platform may determine its position relative to control points or control lines, as represented by the passive landmarks that are detectable by the sensor system of the mobility platform.

As used herein, a “passive landmark” refers to a landmark lacking equipment that provides navigational signals to a mobility platform. In some embodiments a “passive landmark” may reflect a signal (e.g., visual and/or infrared light such as a laser) originating from onboard the mobility platform. In some embodiments, a passive landmark may be completely unpowered, such that the passive landmark is a physical object with no power source. In some embodiments, a passive landmark may include an illumination source (e.g., one or more lights). The illumination source may be configured to illuminate the landmark to improve reliability of identification by a mobility platform (e.g., by providing a consistently colored landmark for visual processing). In some embodiments, light from the illumination source may be received by the mobility platform for tracking the passive landmark or otherwise identify the passive landmark compared with other objects within a worksite. However, light from an illumination source of the passive landmark may not be a navigational signal employed for the determination of position of the mobility platform relative to the passive landmark. In this manner, a passive landmark may remain relatively simple and inexpensive compared to complex RF beacons or surveying equipment employed in conventional systems, as the navigational hardware may reside solely on the mobility platform, and navigational signals sensed by the mobility platform may originate on the mobility platform.

The mobility platform of exemplary embodiments described herein may be capable of performing various tasks and services through the transportation, positioning, and operation of automated tools, without human users. Tasks which may be performed include translating digital designs into real-world layouts (e.g., accurately marking the location of specific architectural/engineering features on the job site), material handling (transporting materials and equipment to the appropriate locations), performing portions of installation work (e.g., marking mounting locations, drilling holes, installing hangers, fabricating materials, preparing equipment, etc.), and/or installing various building systems (e.g., wall systems, mechanical systems, electrical systems, plumbing systems, sprinkler systems, telephone/data systems, etc.). A mobility platform may be fitted with one or more tools, including, but not limited to: marking devices (e.g., printers, brushes, markers, etc.), material handling and manipulation systems (arms, grapples, grippers, etc.), rotary tools (e.g., drills, impact wrenches, saws, grinders, etc.), reciprocating tools (e.g., saws, files, etc.), orbital tools (e.g., sanders, cutters, etc.), impact tools (e.g., hammers, chipping tools, nailers, etc.), and other power tools, including the equipment required to support them (e.g., compressors, pumps, solenoids, actuators, presses, etc.).

The embodiments below will describe various systems (e.g., mobility platforms) and portions of systems in terms of their state in three-dimensional space. As used herein, the term “position” refers to the location of an object or a portion of an object in a three-dimensional space (e.g., three degrees of translational freedom along Cartesian x-, y-, and z-coordinates). As used herein, the term “orientation” refers to the rotational placement of an object or a portion of an object (three degrees of rotational freedom—e.g., roll, pitch, and yaw).

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

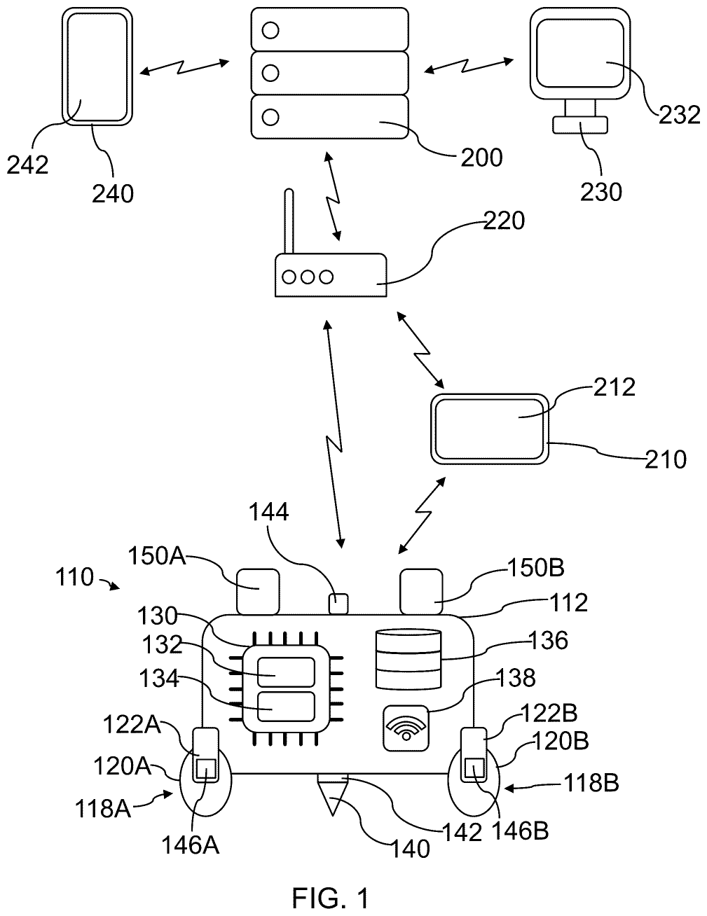

FIG. 1 is a schematic of one embodiment of a construction assistance system including a mobility platform 110 for navigation in a worksite. As shown in FIG. 1, the system may include one or more computer processors that interpret various types of data. Those computer processors may be programmed to implement functions such as extracting information about a worksite from a design file, receiving input specifying one or more tasks to be performed at one or more task locations, determining or executing a path for the mobility platform to traverse to perform tasks, determining landmark locations for one or more landmarks, and generating commands to the mobility platform to perform the tasks to be performed. Those processors may be in the same location or distributed across multiple locations. In some embodiments, some processors may be on the mobility platform 110 and others may be in one or more remote devices that may be connected to the internet or other wired and/or wireless communication network.

As shown in FIG. 1, the mobility platform may navigate and operate autonomously or semi-autonomously and may communicate with one or more remote or local devices. In the embodiment of FIG. 1, the mobility platform includes a variety of controllers and sensors mounted on a chassis 112 which enable high precision navigation in a worksite based on passive landmarks placed in the worksite. In some embodiments as shown in FIG. 1, the mobility platform 110 of FIG. 1 includes a controller 130 having a motion control unit 132 and a tool control unit 134.

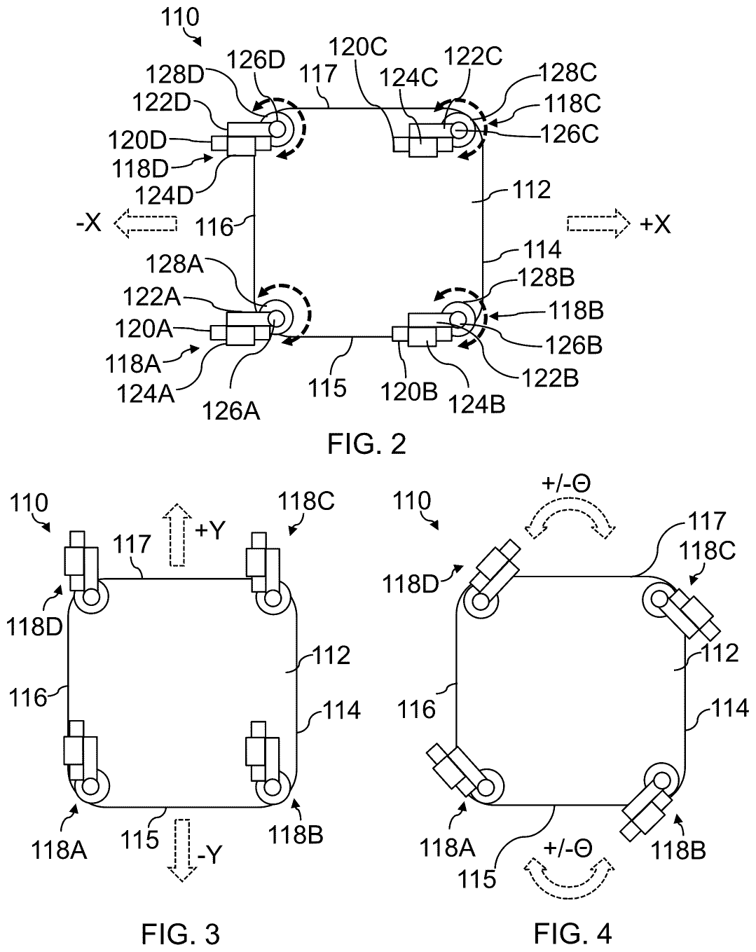

The motion control unit 132 is configured to control a drive system including at least a first wheel 120A driven by a first actuator and a second wheel 120B driven by a second actuator (for example, see FIGS. 2-4). In some embodiments, the drive system is a holonomic drive system, which in the illustrated embodiment, allows the mobility platform to move omnidirectionally in three degrees of freedom, as will be discussed further with reference to FIGS. 2-4.

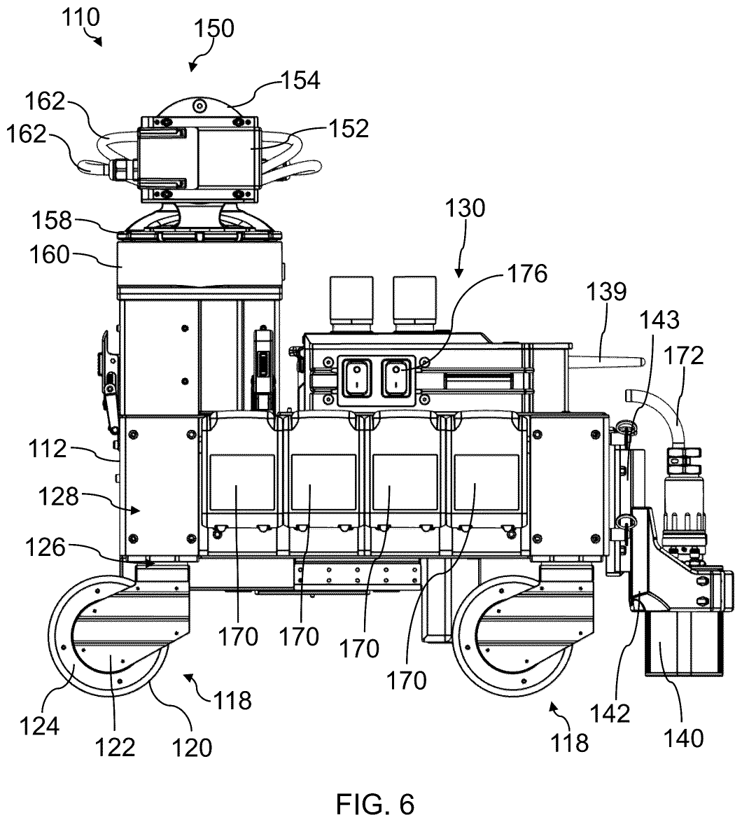

The tool control unit 134 is configured to control the activation and/or motion of one or more tools mounted on the mobility platform 110. The tool control unit may issue one or more commands to an associated tool to perform one or more tasks. In the configuration shown in FIG. 1, the mobility platform includes a marking device 140 mounted on a carriage 142 which allows the marker to reach the extremities of the chassis 112 of the mobility platform. The tool control unit is configured to control the movement of the marking device on the carriage and deposit inks, powders, or other effective marking materials to layout a worksite according to a design file. The marking device may make marks on features in the worksite, such as walls and floors, pillars, ceilings etc. in response to commands from the tool control unit. The carriage may position the marking device in an appropriate task location in response to commands from the tool control unit. Other commands from the tool control unit may control parameters of marking such as line thickness, color, material, etc. In some embodiment, the carriage may move the marking device to allow the marking device to reach desired positioned relative to the chassis 112. In some embodiments, the carriage may be stationary and may not move the marking device. In some embodiments, the marking device 140 may be a printer configured to make multiple markings at once. An exemplary marking device 140 is discussed further with reference to FIG. 6.

As shown in FIG. 1, the mobility platform 110 includes a sensor system including a plurality of sensors configured to acquire and/or output information regarding the surroundings of the mobility platform so that the mobility platform may navigate autonomously using passive landmarks placed or otherwise pre-existing in a worksite. According to the depicted embodiment, the mobility platform includes a first wheel odometer 146A, a second wheel odometer 146B, a first laser rangefinder 150A, and a second laser rangefinder 150B. As will be discussed further below, the information acquired and/or output by each of the sensors may be fused by the controller 130 as the mobility platform navigates through a worksite. In some embodiments, information from the first wheel odometer 146A and the second wheel odometer 146B may be used for real time navigation within a worksite, including determinations of an estimated position and orientation of the mobility platform. In some embodiments, information from the first laser rangefinder 150A and the second laser rangefinder 150B may be used for real time navigation within a worksite, for example, by tracking two passive landmarks as the mobility platform moves through the worksite. In some embodiments, information from the first laser rangefinder 150A and the second laser rangefinder 150B may be used to verify a position and orientation of the mobility platform within the worksite. In some embodiments, the information from the first laser rangefinder 150A and the second laser rangefinder 150B may be employed to reset error in the estimated position or orientation and may be employed to calibrate the estimations of position and orientation based on information from the first wheel odometer 146A and the second wheel odometer 146B. In some embodiments, an independent local position and orientation may be determined through integration (e.g., the mathematical function) of the information from the first and second wheel odometers 146A, 146B, while global positions are generated through passive landmark measurement via the first and second laser rangefinders 150A, 150B. In some embodiments, an independent local position may be based on odometry information including measurements from sensors other than wheel odometers, such as measurements an inertial measurement unit. Comparison of the independently generated local position and global position may allow the mobility platform to self-test positional accuracy and recalibrate one or more parameters used in local position determination as the mobility platform navigates the worksite. Any suitable number or type of sensors may be employed, and their data fused, combined, or compared to improve the accuracy and/or precision of autonomous navigation in a worksite, as the present disclosure is not so limited. For example, an inertial measurement unit 144 may be employed in addition to or instead of the wheel odometers. In such embodiment, acceleration information may be integrated (e.g., the mathematical function) over time to determine changes in position and/or orientation of the mobility platform. Such a computation may be prone to error such as drift, which may be corrected by the information from the first and second laser rangefinders 150A, 150B.

While a specific combination of odometry sensors is shown and described with reference to the embodiment of FIG. 1 (e.g., wheel odometers and an inertial measurement unit), in some embodiments other odometry sensors may be employed alone or in combination. Odometry sensors employed to obtain odometry information used in determining an estimated position and/or orientation according to methods herein may include, but are not limited to, one or more wheel odometers (e.g., rotary encoders, stepper motors, potentiometers, etc.), inertial measurement units, accelerometers, and optical flow sensors. In some embodiments, a single odometer sensor or sensor type may be employed. For example, in some embodiments, odometry information may be sourced solely from one or more wheel odometers. As another example, in some embodiments, odometry information may be sourced solely from an inertial measurement unit. In other embodiments, multiple odometry sensors of different types may be employed and fused to provide odometry information.

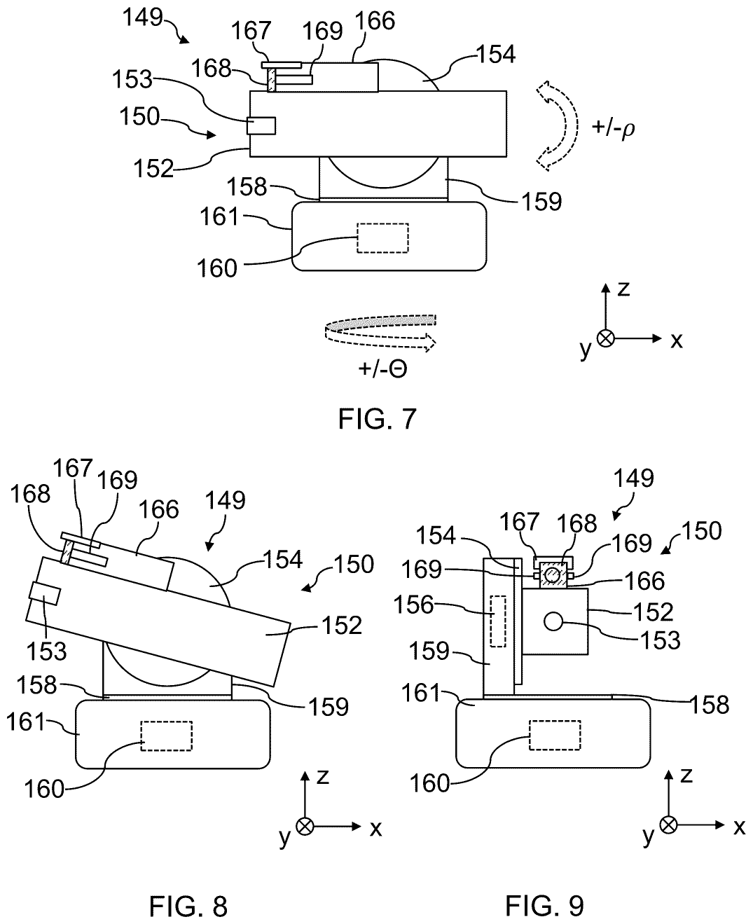

Additionally, while the embodiment of FIG. 1 may employ wheel odometry and/or an inertial measurement unit, in some embodiments a sensor system for navigation of a mobility platform may be based solely or primarily on the first laser rangefinder 150A and the second laser rangefinder 150B. For example, the first laser rangefinder 150A and the second laser rangefinder 150B may track passive landmarks by moving in a yaw direction as the mobility platform moves throughout a worksite. In some embodiments as will be discussed with reference to the example of FIGS. 7-9, a sensor system may include a camera and infrared light source disposed on a housing including the laser rangefinder. Image information from the camera may be employed to visually detect passive landmarks in a worksite using computer vision, which may allow tracking of the passive landmark with the laser rangefinder so that distance information may be measured in real time as the mobility platform moves through the worksite. In some cases, the yaw angle of the laser rangefinder may be adjusted to maintain a detected passive landmark within an image in a center of the frame. Examples of such a process are discussed further with reference to FIGS. 18A-20.

In the embodiment shown in FIG. 1, the mobility platform 110 also includes additional external devices that cooperate with the controller 130 to allow the mobility platform to navigate and perform tasks autonomously in a worksite. For example, the mobility platform includes a storage device 136 such as a hard drive, solid state drive, or other memory for storing instructions or other data, as well as a wireless communicator 138 which communicates to various local or remote devices wirelessly through any appropriate communication protocol (e.g., satellite, cellular, Wi-Fi, 802.15.4, etc.). While the mobility platform of FIG. 1 communicates wirelessly, any suitable wired communication interface may also be employed, such as a wired serial port, Ethernet port, etc. The combination of the storage device and the wireless communicator enables the mobility platform to send, receive, and store data from one or more external devices, such as a remote server 200 (i.e., cloud server), remote computer 230, mobile device 240, or local workstation 210 (e.g., a portable or handheld device such as a laptop, tablet, or mobile phone, a desktop computer, or any other appropriate device which is within wireless or wired range of the mobility platform and/or network access point so that the workstation can communicate with or control the mobility platform from the worksite). Such an arrangement may allow a file served from a remote server to be analyzed by one or more of the remote server, remote computer, mobile device, or local workstation to generate paths, tasks, task locations, landmark locations and other relevant information that the mobility platform 110 may use to perform tasks autonomously or semi-autonomously in a worksite.

As noted above, the mobility platform 110 of FIG. 1 is configured to communicate with a plurality of external devices to simplify navigating autonomously and performing one or more tasks. The external devices that communicate directly or indirectly with the mobility platform include a remote server 200, workstation 210, router 220, remote computer 230, and mobile device 240. In some embodiments, the remote server, which may be located in a data center as part of a cloud computing service, is employed to manage the files used by the mobility platform to navigate and perform tasks. That is, the remote server may coordinate file management, path generation, path correction, task planning, and any other desirable functions. In some embodiments, path correction may be coordinated onboard the mobility platform 110. The remote server allows designers, such as contractors, consultants, engineers and architects, to provide design files and task information which may be employed by the mobility platform. In some embodiments, the remote server may automatically generate drive paths for performing tasks at a variety of locations in a worksite by extracting information from a design file such as a 2D or 3D drawing or CAD file. Engineers, architects, or other remote workers may interface with the remote server from industry-standard file management platforms, or via web interface where files are uploaded, either of which may be on the mobile device 240 or remote computer 230. A mobile device graphical user interface 242 or a remote computer graphical user interface 232 may be used to transmit or download files from the remote server and modify files using CAD or Building Information Management (BIM) software platforms. The file management system employed on the remote server may include a database for storage of drawings, plans, and relevant data, and may also be fitted to provide users with modification history of files in store. The remote server also enables contractors, tradesmen, or other workers locally available at the worksite to provide feedback to paths, task locations, landmark locations, or control parameters. In particular, the remote server may communicate with the workstation 210 having a graphical user interface 212. The graphical user interface 212 may allow a user to confirm, modify, or deny navigation and task plans generated by the remote server onsite before the mobility platform begins operating autonomously. In some cases, the workstation may also be used to manually override or manually control the mobility platform. According to the embodiment of FIG. 1, the router 220 may be configured as a modem, satellite, cellular tower, or other suitable interface suitable to coordinate data transmissions between the remote server, mobility platform, and/or workstation.

It should be noted that while a remote server 200 is shown and described with reference to FIG. 1, any appropriate server or processor may be used, including servers and processors located locally (e.g., onboard the mobility platform) or in close proximity to a worksite, as the present disclosure is not so limited.

FIG. 2 is a top schematic view of one embodiment of a mobility platform 110 including a holonomic drive system enabling the mobility platform to move in three degrees of freedom and reach the extremities of a worksite. The holonomic drive system allows the mobility platform to position a tool mounted on the mobility platform in a region flush with an extremity of a worksite, such as a corner or adjacent an obstacle, which may otherwise necessitate multiple movements to reach or be inaccessible. The holonomic drive system allows the mobility platform 110 to translate in any direction in a plane, as well as rotate within that plane to change a position and/or orientation of the mobility platform. The drive system of the mobility platform 110 includes a four wheel assemblies 118A, 118B, 118C, 118D coupled to a chassis 112 of the mobility platform. Each of the wheel assemblies includes a respective wheel 120A, 120B, 120C, 120D coupled to a respective support 122A, 122B, 122C, 122D. The wheels 120A, 120B, 120C, 120D are each coupled to a first actuator 124A, 124B, 124C, 124D that is configured to rotate the wheel about a wheel axis to move the mobility platform 110. According to the embodiment of FIG. 2, each the wheel assemblies 118A, 118B, 118C, 118D includes a respective swivel axle 126A, 126B, 126C, 126D. Each of the four wheels rotates about a respective swivel axle independently, which allows the wheels to be angled at any angle (e.g., 0 to 360 degrees) relative to a chassis 112 of the mobility platform. The wheel assemblies also each include an axis actuator 128A, 128B, 128C, 128D configured to rotate a respective wheel about a respective swivel axle. In some embodiments, an axis actuator may be a servomotor. The axis actuators allow the wheel axis of each of the wheels to be adjusted (e.g., swiveled) independently, so that the mobility platform may move freely in three degrees of freedom. This arrangement provides complete motion (e.g., along a planar floor of a worksite) and enables execution of complex motion patterns for the accomplishment of certain tasks. As discussed further below, one such benefit is the ability to mark continuous curves on a worksite floor. While independently rotatable wheels are shown in FIG. 2, any suitable holonomic drive system may be employed such as omnidirectional wheels in other embodiments. In other embodiment, a drive system that is not holonomic may be employed, as the present disclosure is not so limited.

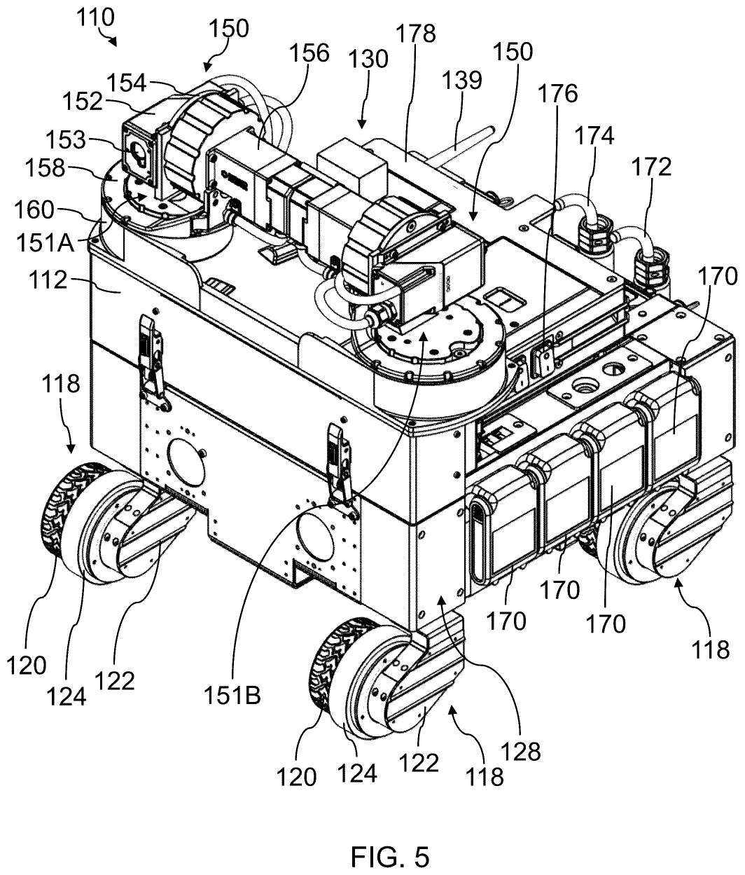

According to the embodiment of FIG. 2, the mobility platform 110 includes a chassis 112 for mounting a variety of tools or payloads. The chassis 112 is coupled to the wheel assemblies 118A, 118B, 118C, 118D, which support and move the chassis. The chassis may have a plurality of hard mounting points which allow tools or payloads to be mounted modularly to the mobility platform. An exemplary chassis is shown and described further with reference to FIGS. 5-6.

FIG. 2 is a top schematic view of the mobility platform 110 in a first state, FIG. 3 is a top schematic view of the mobility platform in a second state, and FIG. 4 is a top schematic view of the mobility platform in a third state which shows the degrees of freedom provided by the holonomic drive system including the wheel assemblies 118A, 118B, 118C, 118D. As shown in FIG. 2, the four wheels 120A, 120B, 120C, 120D have parallel wheel axes. Accordingly, the mobility platform may move in the +X or −X direction as shown in FIG. 2 by rotating the four wheels with the actuators 124A, 124B, 124C, 124D.

As shown in FIG. 3, the wheels have been rotated to facilitate movement of the mobility platform along the +Y or −Y direction. That is, each of the axes of rotation of the wheels has been moved by the respective axis actuator, so that the wheel axes are parallel to one another and are rotated approximately 90 degrees relative to the state shown in FIG. 2. Accordingly, the mobility platform may move in the +Y or −Y direction as shown in FIG. 3 by rotating the four wheels with the actuators 124A, 124B, 124C, 124D. To reach the state shown in FIG. 3, a drive path may include commands that specify which wheel axis to rotate and the magnitude of the desired rotation. Alternatively, controller of the mobility platform (e.g., a motion control unit) may generate corresponding commands to each of the wheel actuators and axis actuators to control the mobility platform to that location. In some embodiments, a server, motion control unit, or any other suitable processor or controller may use any suitable task command to control the motion of the mobility platform, including combinations of the task commands described above, as the present disclosure is not so limited. Accordingly, the mobility platform may move easily along either the +/−X direction or the +/−Y direction.

As shown in FIG. 4, the holonomic drive system is in the third state, where the wheel axes of rotation for the first wheel 120A and the third wheel 120C are aligned, and the wheel axes of rotation for the second wheel 120B and the fourth wheel 120D are aligned and perpendicular to the axes of the first and third wheels. In the configuration shown in FIG. 2, the mobility platform is capable of moving in three degrees of freedom by varying direction of rotation of the wheels about their various axes of rotation. Additionally, the state shown in FIG. 4 allows the wheels to be driven to rotate the mobility platform in a plane in the +0 or −θ direction. Accordingly, the holonomic drive system is capable of moving the mobility platform along a first axis (+/−X), a second axis perpendicular to the first axis (+/−Y), and also change the orientation of the mobility platform about a third axis (+/−θ). The axes of the wheels may be adjusted without moving the mobility platform itself from an initial position, allowing the mobility platform to be moved in any of the three degrees of freedom from an initial position. For example, one or more axis actuators may adjust the axes of the wheels upon command from a motion control unit. Additionally, an orientation of the mobility platform may be changed without changing a position of the mobility platform, where the position of the mobility platform is represented as an average position (e.g., a geographic center, center of mass) or other point position.

According to the embodiment of FIGS. 2-4, the holonomic drive system may enable the mobility platform to move in any of the three degrees of freedom described above concurrently. For example, the drive system may allow the mobility platform to move in the +X direction and +θ direction at the same time. Any combination of movement in any of the three degrees of freedom may be provided by the holonomic drive system of FIGS. 2-4, as the present disclosure is not so limited.

FIG. 5 is a perspective view and FIG. 6 is a side view of an exemplary embodiment of a mobility platform 110. As shown in FIGS. 5-6, the mobility platform 110 includes a chassis 112. The chassis 112 is supported by a drive system including a plurality of wheel assemblies 118. The wheel assemblies each include a wheel 120, a support 122, a wheel actuator 124, a swivel axle 126, and a swivel actuator 128. The drive system of FIGS. 5-6 is holonomic, such that the chassis 112 is moveable in any direction within a plane, as discussed above with reference to FIGS. 2-4. The wheel assemblies may each include a wheel odometer configured to measure a distance traveled by the wheels.

As shown in FIGS. 5-6, the mobility platform 110 includes a controller 130 that is mounted to the chassis 112 in a controller housing 178. The controller 130 may include one or more processors configured to execute computer-readable instructions to perform exemplary methods described herein. The controller 130 may include an antenna 139, which may be used by a wireless communicator 138 to allow the controller to communicate wirelessly with other external devices. In some embodiments, a laser rangefinder 150 may include one or more processors. In some embodiments, methods described herein or portions of methods described herein may be performed in firmware on a laser rangefinder 150.

The mobility platform 110 of FIGS. 5-6 also include a power source. The power source of FIGS. 5-6 comprises a plurality of batteries 170. The batteries 170 may be modular, such that one or more batteries may be selectively coupled to the chassis 112 for providing power to the various components of the mobility platform 110. In the embodiment of FIGS. 5-6, the chassis 112 may be configured to accommodate up to eight batteries. In other embodiments, a single battery may be employed. In some embodiments, non-modular batteries may be employed, as the present disclosure is not so limited. In some embodiments, a wired power source may be employed, as the present disclosure is not so limited. As shown in FIGS. 5-6, in some embodiments a mobility platform may include one or more switches 176 that may be used by a user to selectively power the mobility platform.

As shown in FIGS. 5-6, the mobility platform 110 includes a marking device 140. The marking device 140 is disposed on a rear of the chassis 112. The marking device is mounted to a rail 143 of the chassis by a carriage 142. In the embodiment of FIGS. 5-6, the marking device 140 does not move, and the carriage forms a stationary connection between the marking device 140 and the chassis 112 once set. In some embodiments, the carriage is configured to move up and down along the rail 143 to allow the height of the marking device 140 to be adjusted by a user. As shown in FIGS. 5-6, a first marking device cable 172 and a second marking device cable 174 may be used to connect the marking device to the controller 130 and/or batteries 170 (or another power source). In some embodiments, the first marking device cable 172 may be used for power only. In some embodiments, the second marking device cable 174 may be used for data transmission only.

In some embodiments, the marking device 140 includes at least one reservoir, at least one air compressor or pump, an electronic control system (ECS), and at least one print head, all appropriately interconnected with tubes, hoses, pipe, values, connectors, wiring, switches, etc. The reservoir(s) may hold sufficient volumes of marking fluid for the printing tool kit to operate for a desired working period. The reservoir(s) may connect to the remainder of the print system, both upstream and downstream, in a way that delivers the marking fluid to the next component required to control and execute the desired mark. In some embodiments, the reservoir(s) holds a marking fluid, such as a pigmented ink, in tanks that can be opened to the atmosphere and filled by hand from bulk containers of marking fluid, but if desired, upon closure the reservoirs are capable of being pressurized. In some embodiments, the top of the reservoir(s) may be connected to the air compressor or air pump with tube, hose or pipe, allowing the air compressor or air pump to pressurize the head space at the top of the reservoir, above the marking fluid, and therefore positively pressurize the marking fluid and feeding it through an ink feed tube, hose, or pipe that connects the bottom of the reservoir to one or more of the print heads. In some embodiments, a reservoir may remain open to the atmosphere, with the bottom tube, hose, or pipe connected to a pump that is capable of drawing fluid from the reservoir and feeding it downstream through the ink feed tube, hose, or pipe to the print head.

In some embodiments, each of the print heads of the marking device 140 is configured to deposit the marking fluid onto the printing surface. In some embodiments, the print head may be formed of an ink feed tube connection to the reservoir or pump, a manifold distributing the marking fluid to key components within the print head, and at least one Piezo-electric pump that, when operated, displaces small increments of the marking fluid into droplet form. The Piezo-electric pump may utilize a disc(s) that is naturally flat, but upon activation, deforms into one of two positions, the draw position or the push position. In the draw position, the positive pressure of the fluid in the ink feed tube and manifold encourages the marking fluid into the Piezo-electric chamber. In the push position, a droplet is forced out of the piezo-electric chamber and deposited onto the floor surface. In some embodiments, an array of Piezo-Electric pumps is used, allowing droplets to be simultaneously deposited in a column, a row, a matrix, a diagonal line, or any combination thereof. Such an array allows the marking of complex shapes and patterns, including text.

In some embodiments, the marking device 140 may also include an electronic control system having a processor configured to execute computer readable instructions stored in memory. The electronic control system may be configured to command the plurality of prints heads and at least one pump to deposit droplets of marking fluid in column, a row, a matrix, a horizontal line, a vertical line, a diagonal line, or any combination thereof. The electronic control system may also communicate with the controller 130 of the mobility platform 110 (e.g., the tool control unit 134) to receive position and velocity information to coordinate the deposits of marking fluid. In some embodiments, the mobility platform and print system may allow the marking of text, or other complex shapes or patterns. In some embodiments, marking fluid is deposited as the mobility platform is in motion. The electronic control system may interface with the task control unit of the mobility platform to receive triggers that activate specific actions required for placing accurate markings on the floor. Additionally, the marking device may provide feedback to the mobility platform through the same interface to provide real time information about printer performance and status. In this manner, the marking device may be a self-contained system that automates the process of releasing a marking fluid based on some external input related to mobility platform timing, location, or other signal.

According to the embodiment of FIG. 1, the printing capability provided by the marking device 140, and specifically the ability to print text, allows the marking device 140 to deliver unique digitally replicated information on the unfinished floor of a worksite. When deployed on a mobility platform 110 of exemplary embodiments described herein, the marking device can mark the intended location of various building systems, components, and equipment, which allows contractors to accurately install their respective materials. While installation locations are currently marked by hand with points and lines, the marking device may have complex marking capabilities, including an ability to print text, which may be used to differentiate between trades, communicate non-intuitive installation instructions (e.g., denote material sizes, identify specific parts or equipment, detail configuration or orientation, and specify installation heights above the floor), and identify prefabricated part numbers. The ability to communicate prefabricated part numbers may be desirable as prefabricated construction techniques become more widespread. Accordingly, the marking device of FIG. 1 in concert with mobility platforms of exemplary embodiments described herein provides the capability of communicating the exact installation location, the exact part number, and the exact installation orientation and configuration, allowing contractors to quickly and correctly install a component where it was intended.

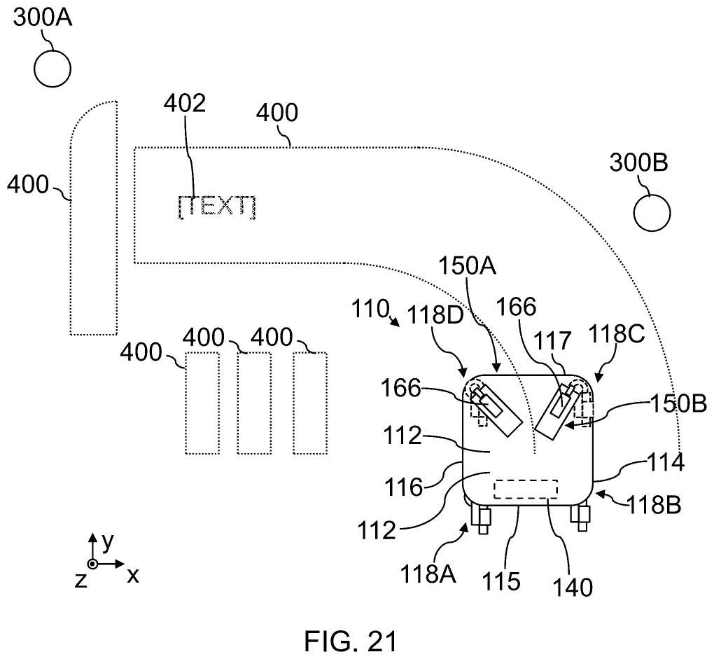

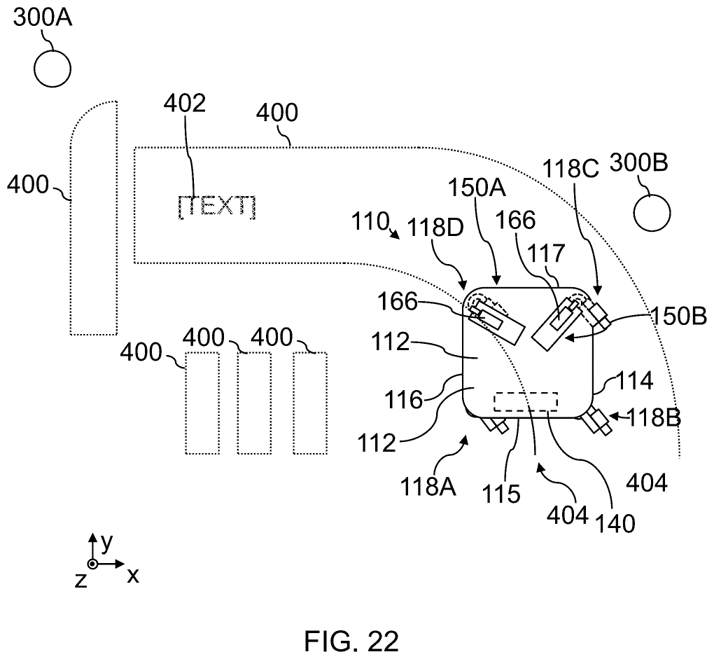

According to the embodiment of FIGS. 5-6, the mobility platform 110 includes two laser rangefinders 150. A first laser rangefinder is disposed at a first location 151A on the chassis. A second laser rangefinder is disposed at a second location 151B on the chassis, which is spaced from the first location. The laser rangefinders are configured to measure a distance from the first location 151A and the second location 151B to a passive landmark disposed in a worksite. As discussed further herein, the use of two laser rangefinders at distinct locations on the chassis allows the orientation of the chassis to be determined based on the distance and yaw angle measurements provided by the laser rangefinders. In the depicted embodiment, a laser rangefinder 150 includes an emitter/receiver 152 configured to emit light through a lens 153 and receive reflected light from an object in the worksite (e.g., a passive landmark). The emitter/receiver is supported by a bracket 154. The bracket includes a base 158 configured to couple the emitter/receiver to the chassis 112. In some embodiments as shown in FIG. 5, a laser rangefinder may be movable in one or more degrees of freedom. As shown in FIG. 5, the laser rangefinder includes a pitch actuator 156 configured to rotate the emitter/receiver about a pitch axis. Additionally, the laser rangefinder includes a yaw actuator 160 configured to rotate the emitter/receiver about a yaw axis. The yaw actuator 160 may be configured to rotate the emitter/receiver within a plane parallel to a plane of the worksite. In some embodiments, the pitch axis may be optional. In such embodiments, the emitter/receiver 152 may be movable relative to the chassis 112 about only the yaw axis. The motion of the laser rangefinder and associated exemplary methods is described further herein with reference to FIGS. 21-22. The emitter/receiver 152 may be connected to the controller 130 via power connections and/or data connections 162.

FIG. 7 is a side schematic of an exemplary embodiment of sensor system 149 of a mobility platform including a laser rangefinder 150 in a first orientation, FIG. 8 is a side schematic of the laser rangefinder in a second orientation, and FIG. 9 is a side schematic of the laser rangefinder in a third orientation. As shown in FIGS. 7-9, the laser rangefinder 150 includes an emitter/receiver 152. The emitter/receiver 152 is configured to emit light through a lens 153 and receive reflected light from an object in the worksite (e.g., a passive landmark). The laser rangefinder may determine a range based on the phase shift of emitted light received back at the emitter/receiver. A phase shift rangefinder may allow for distance measurement on any surface in a worksite. The emitter/receiver is supported by a bracket 154. The bracket is coupled to a base 158 configured to couple the emitter/receiver to a chassis of a mobility platform. The laser rangefinder of FIGS. 7-9 is movable in two degrees of freedom. As shown in FIGS. 8-9, the laser rangefinder includes a pitch actuator 156 disposed in a pitch actuator housing 159 configured to rotate the emitter/receiver about a pitch axis. In particular, the pitch actuator 156 may rotate the bracket 154. Additionally, the laser rangefinder includes a yaw actuator 160 configured to rotate the emitter/receiver about a yaw axis. The yaw actuator 160 is configured to rotate the base 158 about the yaw axis. The yaw actuator 160 may be disposed in a yaw actuator housing 161, as shown in FIGS. 7-9. In some embodiments, the pitch actuator 156 and yaw actuator 160 may provide feedback information regarding the orientation of the emitter/receiver about one or more of the pitch axis and yaw axis to at least one processor of a mobility platform. In some embodiments, a laser rangefinder may include one or more sensors (e.g., potentiometers, rotary encoders, accelerometers, etc.) that provide information regarding the orientation of the laser rangefinder relative to the chassis or a worksite reference frame.

As shown in FIG. 7, the emitter/receiver 152 is configured to change in orientation about a pitch axis and a yaw axis based on forces applied to the emitter/receiver by the pitch actuator 156 and the yaw actuator 160. In the state shown in FIG. 7, the pitch axis is parallel to the y-axis, and may be always parallel to an xy plane. Accordingly, the pitch actuator 156 may adjust an angle of the emitter/receiver about the pitch axis in a +p or-p direction. In the state shown in FIG. 7, the yaw axis is parallel to the z-axis, and may be always perpendicular to an xy plane. Accordingly, the yaw actuator 160 may adjust an angle of the emitter/receiver about the pitch axis in a +θ or −θ direction. FIG. 8 depicts the emitter/receiver 152 with an orientation changed in the +ρ direction relative to the state shown in FIG. 7, such that the emitter/receiver is inclined relative to a horizontal plane. FIG. 8 depicts the emitter/receiver 152 with an orientation changed in the +θ direction relative to the state shown in FIG. 7, such that the emitter/receiver is oriented in a different direction with the xy plane.

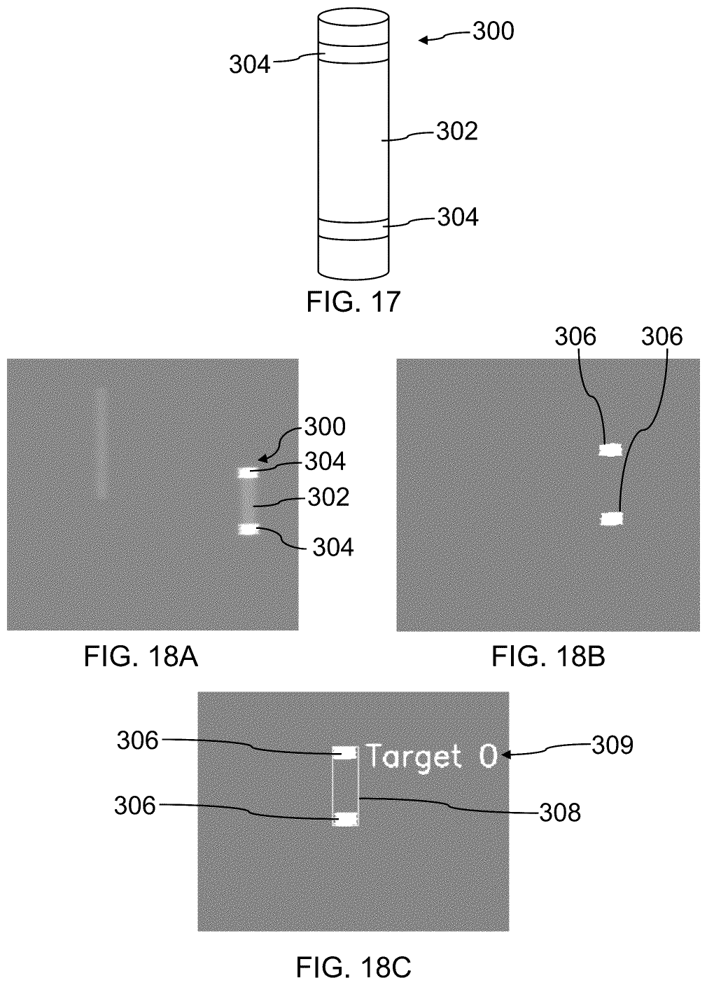

In some embodiments as shown in FIGS. 7-9, a laser rangefinder may include a camera 166 which is disposed on a common housing with the laser rangefinder 150. In some embodiments as shown in FIGS. 7-9, the camera 166 may be disposed on a housing of the laser rangefinder. The camera 166 may collect visual image information regarding a worksite. In some embodiments, the camera is configured to capture images including infrared light. Information from the camera 166 may be provided to at least one processor of a mobility platform, which may use the information to identify a passive landmark for landmark acquisition, as discussed further with reference to FIGS. 17-19C. Various image processing techniques may be applied to the information to identify a passive landmark. For example, shape recognition, machine vision, or machine learning may be applied to information obtained by a camera for recognition and identification of a passive landmark. In some embodiments, an illumination source of a passive landmark may emit light that is identifiable in the information provided by the camera. In some embodiments, a reflectivity of a passive landmark may be identifiable in the information provided by the camera. As the camera 166 is mounted to the emitter/receiver 152, information regarding the reference frame of an image obtained by the camera may be known based on orientation information of the emitter/receiver. Similarly, a position of the camera may be known based on position information of an associated mobility device. Accordingly, processing an image obtained by a camera with a known orientation and position may allow at least one processor to estimate a position of a passive landmark included in the image.

In some embodiments, the camera 166 may be used to “sight” the emitter/receiver. For example, an image from the camera 166 may be processed such that a passive landmark is identified in the image. Once the passive landmark is identified, the orientation of the emitter/receiver may be changed to center the passive landmark within the image or otherwise position the passive landmark in a desired location within the image. Once the passive landmark is within the desired portion of the image, the emitter/receiver may be oriented at the passive landmark. In some embodiments, correct orientation of the emitter/receiver toward the passive landmark may be verified with distance measurements from the laser rangefinder. In some embodiments a camera may be positioned on another portion of a mobility platform, as the present disclosure is not so limited.

In some embodiments as shown in FIGS. 7-9, the sensor system 149 includes an infrared light source 169. The infrared light source is configured to emit infrared light in a light beam angle to illuminate passive landmarks within a worksite. In some embodiments, the passive landmarks may be reflective to infrared light such that the reflectivity may be identified in an image captured by the camera 166. In some embodiments, the light beam angle of the infrared light source and the field of view of the camera 166 may overlap. Accordingly, the infrared light source may illuminate surfaces including passive landmarks within the field of view of the camera 166. In some embodiments, the infrared light source may comprise a plurality of infrared light emitting diodes. In some embodiments, the plurality of infrared light emitting diodes may be spaced apart from one another and/or positioned in a pattern to provide a desired illumination pattern in the field of view of the camera 166. In some embodiments, the infrared light source may emit light having a wavelength of approximately 940 nm. Infrared light may be desirable to avoid interference in images captured by the camera 166, so that a passive landmark may be more reliably detected in image information. In some embodiments as shown in FIGS. 7-9, the camera 166 may include an infrared band pass filter 168 disposed over a lens of the camera. The infrared band pass filter may reject or otherwise reduce the intensity of light outside of a wavelength range of 928 to 955 nm. Put alternatively, the infrared band pass filter may isolate a range of wavelengths between 928 and 955 nm.

In some embodiments as shown in FIGS. 7-9, the sensor system 149 may include a hood 167 for the camera 166 and the infrared light source 169. The hood 167 may be configured to obstruct a portion of the field of view of the camera 166, so as to reduce glare and other artifacts caused by light sources that are not the laser rangefinder 150 or the infrared light source 169. For example, the hood 167 may obstruct an upper portion of the field of view to avoid glare caused by the sun. The hood 167 may also obstruct a portion of the light beam angle of the infrared light source 169. Such an arrangement may direct infrared light from the infrared light source in a direction toward passive landmarks and avoid illumination of other surfaces that may reflect infrared light.

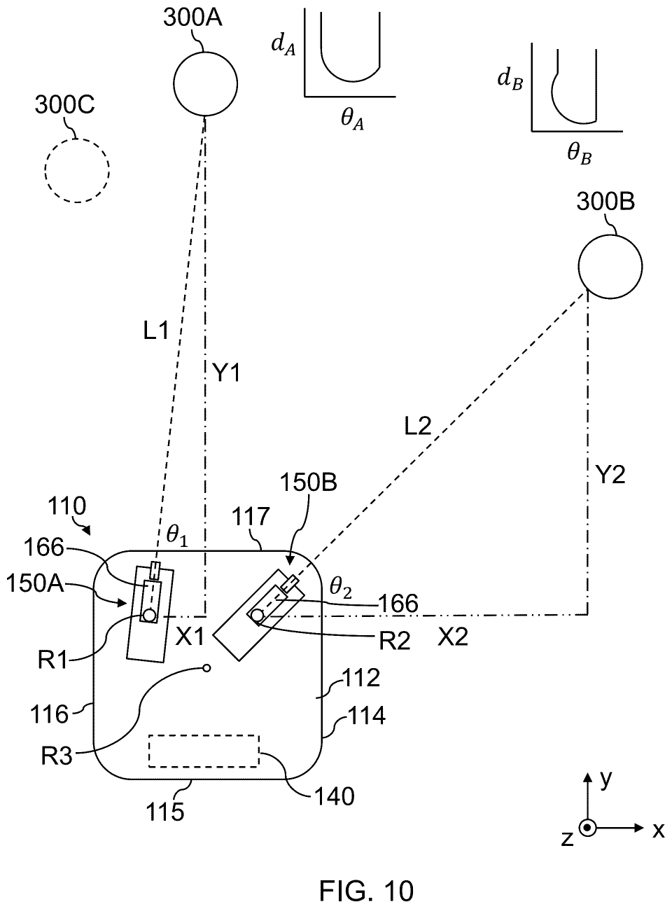

FIG. 10 is a top schematic view of an exemplary embodiment of a mobility platform 110 and a plurality of passive landmarks 300A, 300B. As shown in FIG. 10, the mobility platform includes a chassis 112. The chassis includes a first side 114, a second side 115, a third side 116, and a fourth side 117. The directions of the sides of the chassis may be representative of an orientation of the chassis 112. The chassis 112 may be supported by a drive system (for example, see FIGS. 5-6), which is omitted from FIG. 10 for the sake of clarity. The chassis may also support a marking device 140 configured to mark a floor of a worksite.

According to the embodiment of FIG. 10, the mobility platform includes a first laser rangefinder 150A and a second laser rangefinder 150B. The first laser rangefinder is disposed at a first location R1 on the chassis 112 and is configured to measure a distance between the first location R1 and an object in a worksite. The second laser rangefinder is disposed at a second location R2 on the chassis 112 and is configured to measure a distance between the second location R2 and an object in the worksite. As shown in FIG. 10, a first passive landmark 300A and a second passive landmark 300B are placed in the worksite. The first laser rangefinder 150A is oriented at the first passive landmark 300A, and the second laser rangefinder 150B is oriented at the second passive landmark 300B. Accordingly, the first laser rangefinder 150A is configured to measure a distance L1 between the first passive landmark and the first location R1, shown in dashed lines. Likewise, the second laser rangefinder 150B is configured to measure a distance L2 between the second passive landmark and the second location R2, also shown in dashed lines.

The distances L1 and L2 may be employed to determine the positions of the first location R1 and the second location R2 within a plane of the worksite (e.g., an xy plane). As shown in FIG. 10, information regarding a yaw angle θ of the first laser rangefinder 150A and the second laser rangefinder 150B may be measured (e.g., by one or more yaw angle sensors) relative to a reference yaw direction. In the embodiment shown in FIG. 10, the reference direction may be parallel to the x axis. In other embodiments, any suitable direction within the xy plane may be employed, as the present disclosure is not so limited. As shown in FIG. 10, the first laser rangefinder 150A is disposed at an angle θ₁ relative to the reference direction and the first laser rangefinder 150B is disposed at an angle θ₂ relative to the reference direction. Based on the angle θ₁ and the distance L1, the xy coordinates of the first landmark 300A may be determined using trigonometry. For example, a distance Y1 shown in a dash-dot line in the y direction may be determined as Y1=sin(θ₁)*L1. As another example, a distance X1 shown in a dash-dot-dot line in the x direction may be determined as X1=cos(θ₁)*L1. Accordingly, at least one processor of a mobility platform may receive the distance L1 and the angle θ₁ and may be able to determine a position of the first location R1 within the xy plane relative to the first landmark 300A. If the position of the first landmark 300A is known, the first location R1 may be determined. Like the first location, the position of the second location R2 may be determined based on the distance L2 and the yaw angle θ₂. For example, a distance Y2 shown in a dash-dot line in the y direction may be determined as Y2=sin(θ₂)*L2. As another example, a distance X2 shown in a dash-dot-dot line in the x direction may be determined as X2=cos(θ₂)*L2. Accordingly, at least one processor of a mobility platform may receive the distance L2 and the angle θ₂ and may be able to determine a position of the second location R2 within the xy plane relative to the second landmark 300B. If the location of the second landmark 300B is known, the second location R2 may be determined. The same process may be completed to determine a position of a laser rangefinder and any landmark where the position is known. With two locations on the chassis 112 fixed in position, the orientation of the chassis 112 may be determined so long as the two locations are uniquely identified and are not the same location (e.g., are spaced from one another).

Notably, the distances L1 and L2 measured by the first laser rangefinder 150A and the second laser rangefinder 150B are to an exterior surface of the first passive landmark 300A and the second passive landmark 300B. In some embodiments, it may be desirable to measure a location relative to a point which each landmark represents (e.g., a control point). In some embodiments, such a point may be disposed at a center of a passive landmark. In the embodiment of FIG. 10, the first landmark 300A and the second landmark 300B are cylindrical, and accordingly a center of each landmark is equidistance from the exterior surface of the landmark off which light measured by a laser rangefinder reflects. Accordingly, in some embodiments, the radius of a cylindrical landmark may be added to the measured distance L1 for use in determination of position of the first location R1 and the second location R2. Such an addition may be suitable if the distances L1, L2 are measured from the surfaces of the cylindrical landmark closest to the locations R1, R2. However, depending on the yaw angle of a laser rangefinder, such an addition may be inappropriate in some circumstances.

As shown in the graphs of FIG. 10, the distances measured by a laser rangefinder may change depending on the yaw angle of the laser rangefinder and the particular passive landmark. For example, a measured distance may increase relative to the true distance between a landmark and laser rangefinder if the yaw angle is not appropriately set. As shown in FIG. 10, the distance d_{A} is minimized where the first laser rangefinder 150A is oriented at a center of the first landmark 300A such that the external surface of the first landmark is closest to the first location R1. For other yaw angles OA, the distance measured increases until there is a discontinuity once the light from the laser rangefinder no longer reflects off the first landmark 300A. In the graph for the first landmark 300A shown in FIG. 10, such a discontinuity is represented as a stepwise increase to infinite distance, though such an increase may be to another object in the worksite or a range limit of the first laser rangefinder 150A. The graph shown in FIG. 10 with reference to the first landmark 300A may represent sweep information. As shown in FIG. 10, a similar graph may be shown for a distance d B measured by the second rangefinder 150B against change in yaw angle θ_{B}, which represents sweep information. As shown in FIG. 10, the distance d_{B} is minimized where the second laser rangefinder 150B is oriented at a center of the second landmark 300B such that the external surface of the second landmark is closest to the second location R2. For other yaw angles θ_{B}, the distance measured increases until there is a discontinuity once the light from the laser rangefinder no longer reflects off the second landmark 300B.

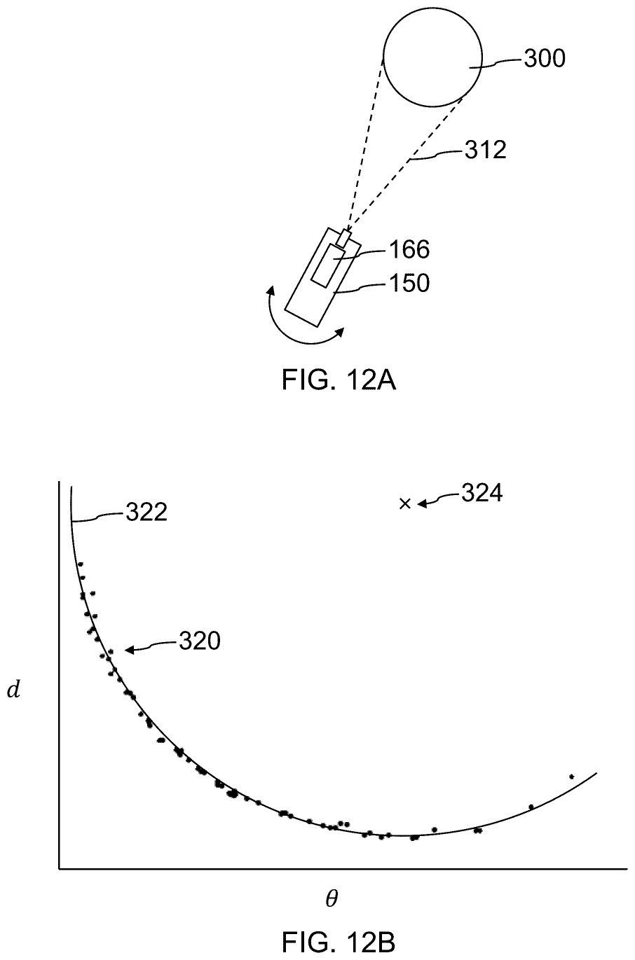

In some embodiments, during a landmark acquisition process a processor may command a laser rangefinder to “sweep” a worksite within a predetermined angular range while the mobility platform is stationary. The processor may obtain distance information similar to the graphs shown in FIG. 10 of distance measured relative to yaw angle, which may be used to determine an appropriate yaw angle for the laser rangefinder. Such a process will be described further with reference to the examples of FIGS. 12A-16. In some embodiments, to determine a position of a location on a chassis, the processor may orient a laser rangefinder to minimize a distance measured from a cylindrical landmark. At the minimized distance, the processor may add the radius of the cylindrical landmark to determine the distance to the center of the landmark. In some embodiments, a processor may identify a shape of a passive landmark in the distance measurements. For example, a partial arc of an ellipse shape as shown in the graphs of FIG. 10 may correspond to a cylindrical landmark. Based on the particular shape, the geometric center of a landmark may be determined. Other shapes for landmarks may be identifiable, including prismatic, faceted, or curved passive landmark shapes. In some embodiments, a successful acquisition may result in a laser rangefinder being oriented toward a geometric center of a passive landmark in the xy plane (or another point used as a known reference point for the determination of position of a location on the chassis 112). In some embodiments, a landmark acquisition process may be completed before moving the mobility platform 110 (e.g., as a part of a startup procedure). In some embodiments, a landmark acquisition process may be performed before the mobility platform performs any task at a task location. Such an arrangement may be beneficial to ensure the mobility platform is in the appropriate task location and in the correct orientation before performing the task. In some embodiments, a landmark acquisition process may be performed to calibrate and/or correct error in position estimation from other sensor sources (e.g., acceleration integration, odometry, etc.). As discussed above, in some embodiments, a camera 166 associated with each laser rangefinder may be employed to perform a landmark acquisition process. Use of a camera 166 may be alternative to other processes described herein (e.g., a “sweep” process) or in addition to such processes. In some embodiments, a “sweep” may be employed while the mobility platform is moving to ensure that a landmark remains acquired through the duration of the movement of the mobility platform. In some embodiments, the camera 166 may be employed to control the laser rangefinders to maintain acquisition of the respective landmarks while the mobility platform is moving.

In some embodiments, as the mobility platform 110 moves or changes in orientation, the first laser rangefinder 150A and the second laser rangefinder 150B may track the first landmark 300A and the second landmark 300B, respectively. In some embodiments, the first laser rangefinder and the second laser rangefinder may be driven to track their respective landmarks based on feedback provided by other sensors of the mobility platform. For example, odometry information from at least one wheel odometer, inertial measurement units, accelerometers, other sensors, or any combination thereof may be used to drive the laser rangefinders to track their acquired landmarks. In some such embodiments, the laser rangefinders may not provide internal feedback information, such that the tracking may be prone to error from the other position and orientation information sources. Accordingly, in some embodiments, laser rangefinders may reacquire the passive landmarks (e.g., stopping the mobility platform and performing a “sweep”) at fixed distance or time intervals during movements of the mobility platform. In some embodiments, laser rangefinders may reacquire the passive landmarks at each task location to verify position and make corrections in position or orientation as appropriate to accomplish the task. In some embodiments, a camera 166 may be employed in feedback control of a laser rangefinder. In such embodiments, the feedback from the camera 166 may be used to maintain acquisition of a landmark, ensuring the reliability of distance measurements. In some such embodiments, no reacquisition process is performed, or fewer reacquisition processes are performed compared to a method including reacquisition at each task location or at fixed time or distance intervals.

In some embodiments, “reacquire” or “reacquisition” may refer to a method of ensuring that a laser rangefinder is appropriately oriented toward the passive landmark for a valid distance measurement. In some embodiments, reacquisition may include finding a passive landmark again according to methods described herein (e.g., a sweep, camera feedback, etc.). For example, during reacquisition of a passive landmark an acquisition process may be independently repeated even if previously completed to ensure the laser rangefinder is correctly targeting the passive landmark.

In some embodiments, at least one processor may detect a discontinuity in the range measurement of a laser rangefinder (e.g., information from a laser rangefinder) while the mobility platform is moving, which may trigger reacquisition of a passive landmark (e.g., passive landmarks 300A, 300B). In some embodiments, a discontinuity may be represented by stepwise increase or decrease in measured distance. In some embodiments, a discontinuity may be determined by a measured distance increasing stepwise above a range change threshold (e.g., 5 cm, 10 cm, 15 cm, 50 cm, 100 cm, etc.) that may be based on a particular worksite and passive landmark size and shape. In some embodiments, a discontinuity may be based on a loss of line of sight to a passive landmark from a laser rangefinder. In such a case, in some embodiments, the laser rangefinder may acquire a separate passive landmark that is within the line of sight of the laser rangefinder.

In some embodiments, if a mobility platform changes position and/or orientation and no discontinuity is detected in the information from a laser rangefinder, the mobility platform may nevertheless reacquire a landmark before performing a task at a task location to verify the global position and orientation of the mobility platform and make any appropriate corrections in position or orientation before performing the task (e.g., marking a floor of a worksite). In some such embodiments, the reacquisition of a passive landmark to verify position where there is no discontinuity may employ a “sweep” through a reacquisition angular range that is smaller than an angular range for an initial acquisition sweep. For example, whereas an initial acquisition sweep may be approximately 180 degrees, a reacquisition angular range may be approximately 30 degrees. Such an arrangement may increase the speed of reacquisition compared to initial acquisition, which may increase the overall speed of task completion by the mobility platform. In some embodiments, a reacquisition angular range may be based on the detection of a discontinuity in range information from a laser rangefinder. For example, once a discontinuity is detected, a laser rangefinder may not move further in the direction of the discontinuity. Such an arrangement may ensure that the laser rangefinder is not oriented in directions in which the passive landmark is not present, avoiding collection of information that is not relevant to position and/or orientation determination, further speeding the position verification process. In some embodiments, a reacquisition angular range may be based on an estimated distance to a passive landmark, where a greater estimated distance reduces the reacquisition angular range. Conversely, a lesser estimated distance may increase the reacquisition angular range. In some embodiments, a reacquisition angular range may be approximately 5 degrees, 10 degrees, 15 degrees, 30 degrees, 45 degrees, or another appropriate angle. In some embodiments, reacquisition may be performed based on information from a camera associated with a laser rangefinder.

In some embodiments, a mobility platform 110 may be configured to determine a position of a third passive landmark 300C that may be optionally placed in a worksite. In some such embodiments, the mobility platform may be configured to determine a position of at least one of the first location R1 and the second location R2. While the mobility platform remains stationary, the laser rangefinder associated with the established position (e.g., the first laser rangefinder 150A for the first location R1 and the second laser rangefinder 150B for the second location R2) may acquire the third passive landmark 300C using methods described above. A distance measured from the established point and the third passive landmark may be used to determine the position of the third passive landmark 300C within the xy plane of the worksite. In some embodiments, a radius of the third passive landmark 300C may be added to the measures distance to determine a geometric center point of the third passive landmark where the third passive landmark is cylindrical. In this manner, additional passive landmarks may be placed within a worksite at unknown landmark positions, and the mobility platform may be configured to establish the landmark positions (e.g., at a center point of the passive landmark) based on measurements relative to at least one passive landmark at a known landmark location. In some embodiments, a position of both the first location R1 and the second location R2 may be determined before the third landmark position is determined to ensure greater accuracy of the third landmark position.

In some embodiments, the distances L1 and L2 measured by the first laser rangefinder 150A and the second laser rangefinder 150B may be employed to determine a distance to geometric center R3 of the mobility platform 110. The distance between the first location R1 and the geometric center R3 may be known based on the arrangement of the chassis 112 and the placement of the first location R1. Likewise, the distance between the second location R2 and the geometric center R3 may be known based on the arrangement of the chassis 112 and the placement of the second location R2. In some embodiments, the known distance(s) between the first location R1 and the geometric center R3, as well as the known distance(s) between the second location R2 and the geometric center R3 may be added to the measured distances L1 and L2, respectively. Such an addition may rectify the distances measured by the laser rangefinders to a single known point on the mobility platform (e.g., a geometric center R3). While a geometric center is employed in some embodiments, in other embodiments any point representative of a position of the mobility platform 110 may be employed, as the present disclosure is not so limited. For example, such a point may be a center of mass or a geometric center of the marking device 140.

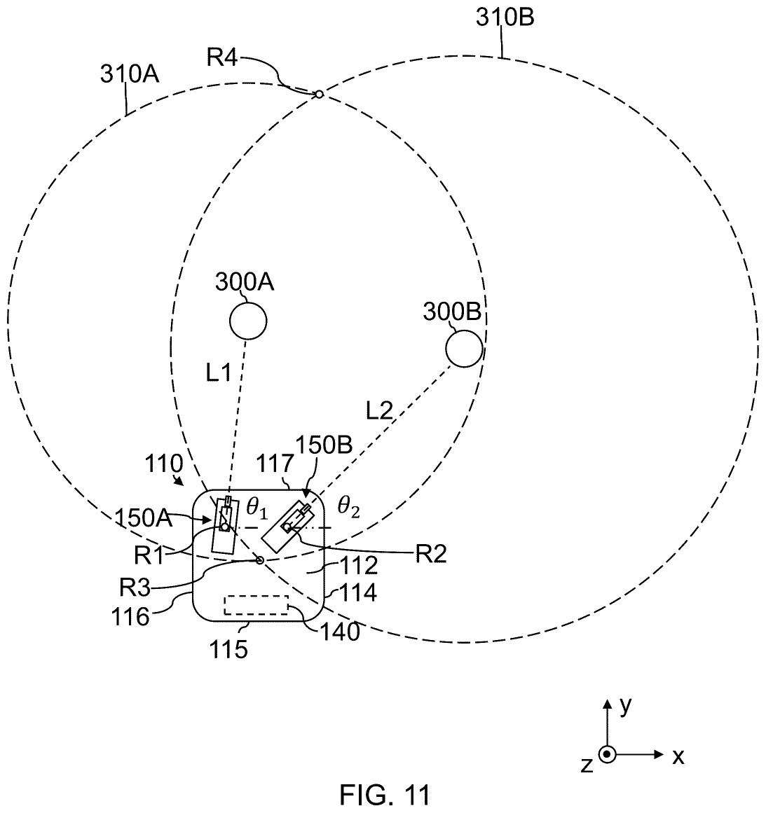

In some embodiment, a position and/or orientation of a mobility platform may be performed according to a process alternative to that described with reference to FIG. 10. FIG. 11 depicts a mobility platform 110 disposed within a worksite. As shown in FIG. 11, the mobility platform includes a chassis 112. The chassis includes a first side 114, a second side 115, a third side 116, and a fourth side 117. The directions of the sides of the chassis may be representative of an orientation of the chassis 112. The chassis 112 may be supported by a drive system (for example, see FIGS. 5-6), which is omitted from FIG. 11 for the sake of clarity. The chassis may also support a marking device 140 configured to mark a floor of a worksite.

According to the embodiment of FIG. 11, the mobility platform includes a first laser rangefinder 150A and a second laser rangefinder 150B. The first laser rangefinder is disposed at a first location R1 on the chassis 112 and is configured to measure a distance between the first location R1 and an object in a worksite. The second laser rangefinder is disposed at a second location R2 on the chassis 112 and is configured to measure a distance between the second location R2 and an object in the worksite. As shown in FIG. 10, a first passive landmark 300A and a second passive landmark 300B are placed in the worksite. The first laser rangefinder 150A is oriented at the first passive landmark 300A, and the second laser rangefinder 150B is oriented at the second passive landmark 300B. Accordingly, the first laser rangefinder 150A is configured to measure a distance L1 between the first passive landmark and the first location R1, shown in dashed lines. Likewise, the second laser rangefinder 150B is configured to measure a distance L2 between the second passive landmark and the second location R2, also shown in dashed lines.

In some embodiments, the distances L1 and L2 measured by the first laser rangefinder 150A and the second laser rangefinder 150B may be employed to determine a distance to geometric center R3 of the mobility platform 110 or another point representative of the mobility platform position, as discussed above with reference to FIG. 10. In some embodiments as shown in FIG. 10, the rectified distances may be employed to determine a circle of possible positions based on the rectified distance measurement. For example, as shown in FIG. 11, a first circle 310A is centered on the first landmark 300A and represents all possible positions for the geometric center R3 of the mobility platform based on the distance measurement from the first laser rangefinder 150A. Additionally, as shown in FIG. 11, a second circle 310B is centered on the second landmark 300B and represents all possible positions for the geometric center R3 of the mobility platform based on the distance measurement from the second laser rangefinder 150B.

In some embodiments, an initial determination of position of the mobility platform 110 based on the distances measured by the first laser rangefinder 150A and the second laser rangefinder 150B may include independently generating the possible positions of the mobility platform based on the measured positions. For example, a first set of possible positions based on the distance measured by the first laser rangefinder 150A may be generated (e.g., first circle 310A). Additionally, a second set of possible position based on the distance measured by the second laser rangefinder 150B may be generated (e.g., second circle 310B). In some embodiments, one or more intersections between the first set of possible positions and the second set of possible positions. In the embodiment of FIG. 11, as there are two laser rangefinders, there will be two intersections between the first set of possible positions and the second set of possible positions. One of the two intersections will be the actual position of the mobility platform (e.g., geometric center R3). The other of the two intersections will be an alternative location R4 that is not the actual position of the mobility platform. Accordingly, in some embodiments using only distance information from the laser rangefinders, the position of the mobility platform may be narrowed to one of two positions within a workspace.

In some embodiments, to resolve the true position between the two intersections determined based on distance measurements from the first laser rangefinder 150A and the second laser rangefinder 150B, yaw angle information from at least one laser rangefinder measured relative to a reference direction may be used. For example, a yaw angle θ₁ of the first laser rangefinder 150A may be employed to distinguish the geometric center R3 at the first of two intersections from the second intersection at alternative location R4. The yaw angle may be measured relative to a reference direction, which in some embodiments may be a Cartesian direction (such as the positive x direction in FIG. 11). Alternatively. a yaw angle θ₂ of the second laser rangefinder 150B may be used to distinguish the geometric center R3 at the first of two intersections from the second intersection at alternative location R4. In some embodiments, only one yaw angle of a laser rangefinder may be employed to resolve the ambiguity between the two possible positions of the mobility platform 110. In some embodiments, both the yaw angle from the first laser rangefinder 150A and the second laser rangefinder 150B may be employed to determine a position of the mobility platform. Additionally, in some embodiments the yaw angles of the first laser rangefinder 150A and the second laser rangefinder 150B may be employed to determine the orientation of the mobility platform 110 within the worksite.

According to exemplary embodiments herein, “information” from a laser rangefinder may refer to one or more sensor outputs from the laser rangefinder itself or associated sensors configured to measure one or more states of the laser rangefinder. For example, information from a laser rangefinder may include measured distance information. As another example, a yaw angle sensor may measure a yaw angle of a laser rangefinder within a plane of the worksite, and such a measured yaw angle may be included in information from a laser rangefinder used in position and/or orientation determination or other methods described herein. As yet another example, a pitch angle sensor may measure a pitch angle of a laser rangefinder about an axis parallel to a plane of the worksite, and such a measured pitch angle may be included in information from a laser rangefinder used in position and/or orientation determination or other processes or other methods described herein.

FIG. 12A is a schematic of an exemplary embodiment of a mobility platform employing a laser rangefinder 150 to determine a position of the laser rangefinder relative to a passive landmark 300. As discussed above, in some embodiments at least one processor of a mobility platform may be configured to determine a relative position of a laser range finder based on measured distance data for points obtained via a sweep of a worksite including the passive landmark 300. During a sweep, distance information may be collected as single points for a plurality of yaw angles represented by arc 312 in FIG. 12A. In some embodiments, the size of the angular arc may be based on the distance of the laser rangefinder to the passive landmark 300, as well as the size of the landmark in an image captured by camera 166. In the embodiment of FIG. 12A, the passive landmark 300 is cylindrical, which appears as a circle viewed in the plane of the worksite.

FIG. 12B is a graph of distance measurements versus yaw angle of the laser rangefinder 150 of FIG. 12A. As shown in FIG. 12B, the distance measurements 320 are representative of an arc of a circle 322 corresponding to the size of the circle of the cylindrical passive landmark 300 shown in FIG. 12A. In some embodiments, at least one processor of the mobility platform may fit a predetermined shape of the passive landmark. For example, the cylindrical landmark may be a circle with a known radius in the plane of the worksite. Accordingly, a circle of the known size may be fit to the measurements. Once fit to the distance measurements 320, a geometric center 324 of the predetermined shape may be identified. In some embodiments, additional points of interest may be identified (for example, a point along the circumference). The geometric center 324 or another point of interest may correspond to a location of a control point or line in the worksite. In some embodiments, once the geometric center or point of interest is identified, the laser rangefinder may be oriented to measure a distance from the passive landmark along an axis passing through the geometric center and/or point of interest. In this manner, the precise distance between the laser rangefinder and the geometric center and/or point of interest may be obtained by the at least one processor by adding the relevant dimension of the passive landmark. In the case of a cylindrical landmark, such a distance may be a radius of the cylindrical landmark.

The process described above with reference to FIGS. 12A-12B may be repeated for multiple laser rangefinders and/or multiple passive landmarks with a single laser rangefinder. In this manner, the relative position of one or more laser rangefinders may be obtained to two or more passive landmarks in a worksite may be obtained, which may be used to triangulate a position of the mobility platform within the worksite (for example, as discussed above with reference to FIGS. 10-11). Additionally, once the position of the mobility platform is determined, such a fitting process may be employed to determine the position of a third passive landmark at an unknown point, and/or the position of other surfaces within a worksite. Accordingly, a worksite plan may be supplemented or amended by shape recognition of various surfaces in a worksite.

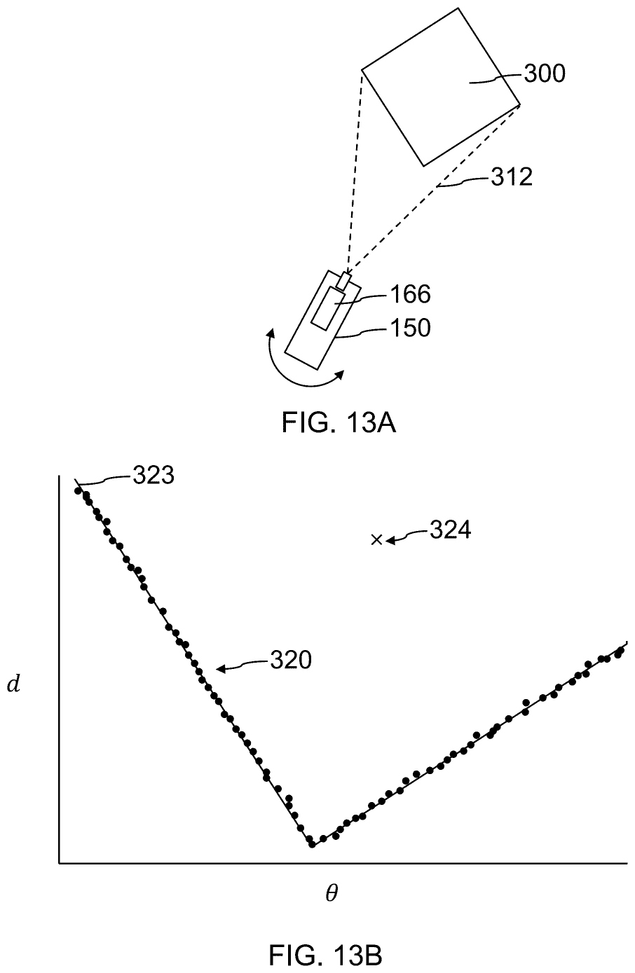

FIG. 13A is a schematic of an exemplary embodiment of a mobility platform employing a laser rangefinder 150 to determine a position of the laser rangefinder relative to a passive landmark 300. As discussed above, in some embodiments at least one processor of a mobility platform may be configured to determine a relative position of a laser range finder based on measured distance data for points obtained via a sweep of a worksite including the passive landmark 300. During a sweep, distance information may be collected as a plurality of single points for a plurality of yaw angles represented by arc 312 in FIG. 13A. In some embodiments, the size of the angular arc may be based on the distance of the laser rangefinder to the passive landmark 300 and/or the size of the landmark in an image captured by camera 166. In the embodiment of FIG. 13A, the passive landmark 300 is a rectangular prism, which appears as a square in the plane of the worksite.

FIG. 13B is a graph of distance measurements versus yaw angle of the laser rangefinder 150 of FIG. 13A. As shown in FIG. 13B, the distance measurements 320 are representative of two faces of a square 323 corresponding to the size of the square of the passive landmark 300 shown in FIG. 13A. In some embodiments, at least one processor of the mobility platform may fit a predetermined shape of the passive landmark. For example, the rectangular prism landmark may be a square with a known side length in the plane of the worksite. Accordingly, a square of the known size may be fit to the measurements. Once fit to the distance measurements 320, a geometric center 324 of the predetermined shape may be identified. In some embodiments, additional points of interest may be identified (for example, a point along the perimeter). The geometric center 324 or another point of interest may correspond to a location of a control point or line in the worksite. In some embodiments, once the geometric center or point of interest is identified, the laser rangefinder may be oriented to measure a distance from the passive landmark along an axis passing through the geometric center and/or point of interest. In this manner, the precise distance between the laser rangefinder and the geometric center and/or point of interest may be obtained by the at least one processor by adding the relevant dimension of the passive landmark.

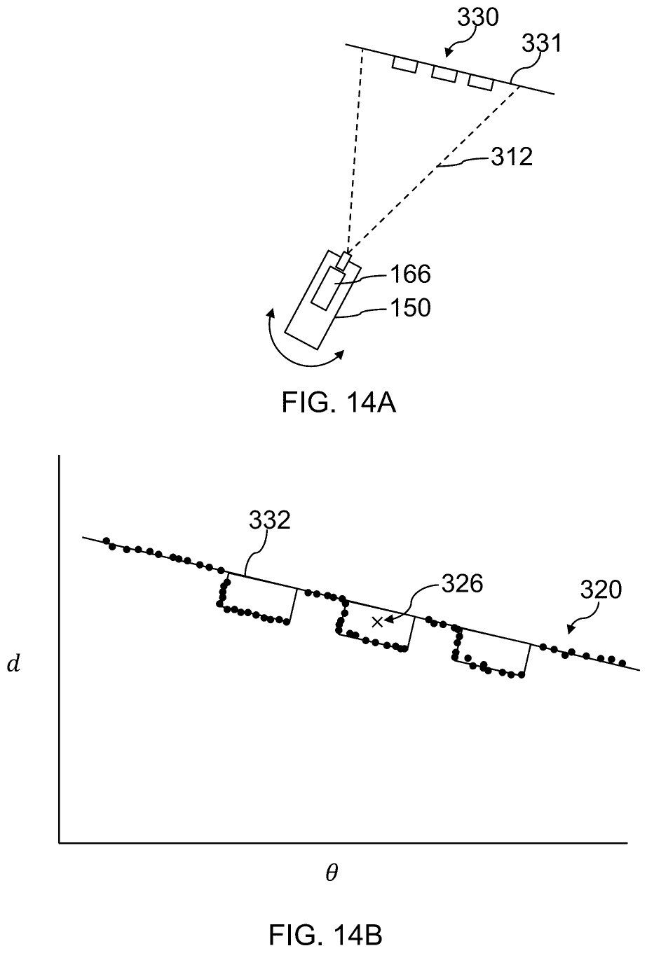

FIG. 14A is a schematic of another exemplary embodiment of a mobility platform employing a laser rangefinder 150 to determine a position of the laser rangefinder relative to a passive landmark 330. In the example, of FIG. 14A, the passive landmark 330 is a sticker disposed on a surface 331. According to the embodiment of FIG. 14A, the sticker includes a pattern detectable by changes in phase shift measured by the laser rangefinder 150. In the example of FIG. 14A, the sticker may have protrusions 332 arranged in a known pattern which may be detectable by changes in distance measured by the laser rangefinder. In other embodiments, the sticker may have changes in reflectivity intensity in a pattern that may be detectable by the laser rangefinder. Similar to the embodiments of FIGS. 12A-13B, the laser rangefinder 150 may sweep the passive landmark 330 and collect a plurality of distance measurements over a plurality of yaw angles, represented by an arc 312. A predetermined shape corresponding to the characteristics of the sticker may be fit to the plurality of distance measurements, so that a point of interest may be identified at a position relative to the position of the laser rangefinder.

FIG. 14B is a graph of distance measurements versus yaw angle of the laser rangefinder of FIG. 14A. As shown in FIG. 14B, the distance measurements 320 are representative of the protrusions 332 of the passive landmark 300 shown in FIG. 14A. In some embodiments, at least one processor of the mobility platform may fit a predetermined shape (in this example, the pattern of protrusions 332) of the passive landmark to the distance measurements 320. For example, the protrusions may have a predetermined spacing relative to one another. Accordingly, a pattern of protrusions with the known spacing may be fit to the measurements. Once fit to the distance measurements 320, a point of interest 326 of the predetermined shape may be identified. The point of interest 326 may correspond to a location of a control point or line in the worksite.

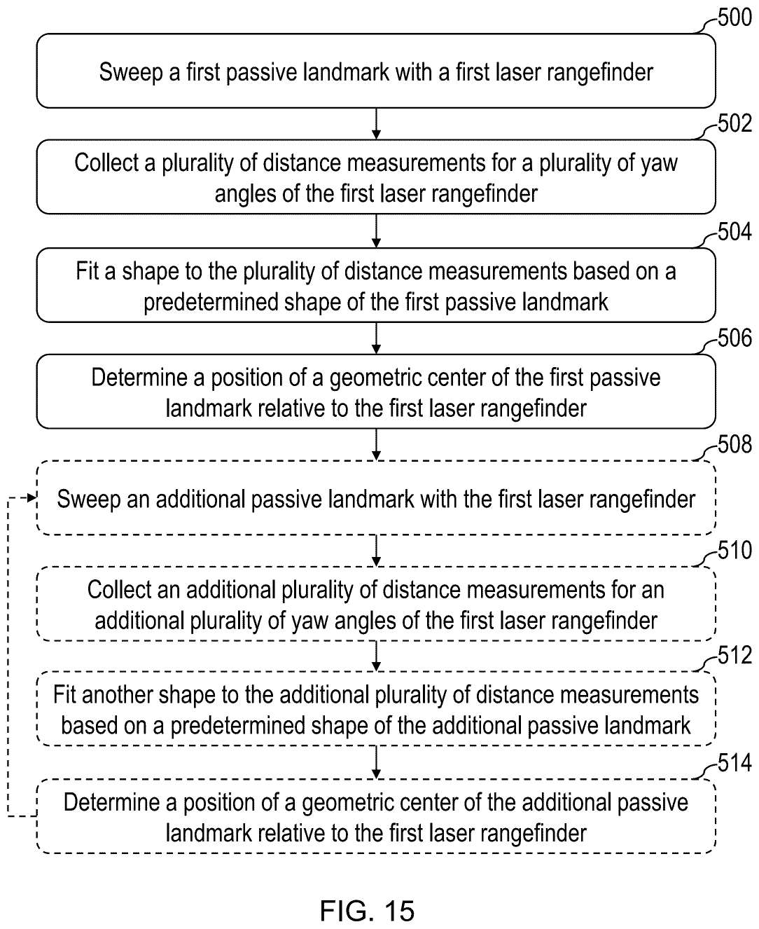

FIG. 15 is a flow chart of an exemplary method of operating a mobility platform. In block 500, a first passive landmark is swept with a first laser rangefinder. In some embodiments, sweeping the first passive landmark may include rotating the first laser rangefinder through a plurality of yaw angles over an angular range. In block 502, a plurality of distance measurements are collected for a plurality of yaw angles of the first laser rangefinder during the sweep of block 500. In block 504, a shape is fit to the plurality of distance measurements based on a predetermined (e.g., known) shape of the first passive landmark. For example, the predetermined shape may have a particular size that may be fit to the collected distance measurements. In some optional embodiments, the method may include determining an error of the fit of the shape to the plurality of distance measurements. If the error is above a predetermined non-zero threshold, the method may include restarting in block 500 and performing another sweep of the landmark to obtain a new plurality of measured distances. Such an arrangement may ensure the fit of the shape to the distance measurements is of appropriate accuracy and precision for localizing a mobility platform. In block 506, a position of a geometric center of the first passive landmark relative to the first laser rangefinder is determined. The geometric center may be a geometric center of the predetermined shape fit to the distance measurements. The geometric center may be with reference to the plane of the worksite.

According to some optional embodiments as shown in FIG. 15, in optional block 508, an additional passive landmark is swept with the first laser rangefinder. In some embodiments, sweeping the additional passive landmark may include rotating the first laser rangefinder through an additional plurality of yaw angles over an angular range that is different than the plurality of yaw angles for sweeping the first passive landmark. In optional block 510, an additional plurality of distance measurements are collected for the additional plurality of yaw angles of the first laser rangefinder during the sweep of block 508. In optional block 512, an additional shape is fit to the additional plurality of distance measurements based on a predetermined (e.g., known) shape of the second passive landmark. In some cases, the additional shape may be different than the shape of the first passive landmark. As noted above, in some optional embodiments, the method may include determining an error of the fit of the additional shape to the additional plurality of distance measurements. If the error is above a predetermined non-zero threshold, the method may include returning to block 508 and performing another sweep of the additional passive landmark to obtain a new plurality of measured distances. Such an arrangement may ensure the fit of the shape to the distance measurements is of appropriate accuracy and precision for localizing a mobility platform. In optional block 514, a position of a geometric center of the additional passive landmark relative to the first laser rangefinder is determined. The geometric center may be a geometric center of the predetermined shape fit to the additional plurality of distance measurements. The geometric center may be with reference to the plane of the worksite.

As shown by the arrow from block 514 to 508, the the steps at blocks 508-514 may be repeated for multiple additional landmarks. For example, in some scenarios there may be several landmarks (e.g., 10-50 landmarks) in the worksite. The method may involve repeating the steps at blocks 508-514 for some or all of the land marks.

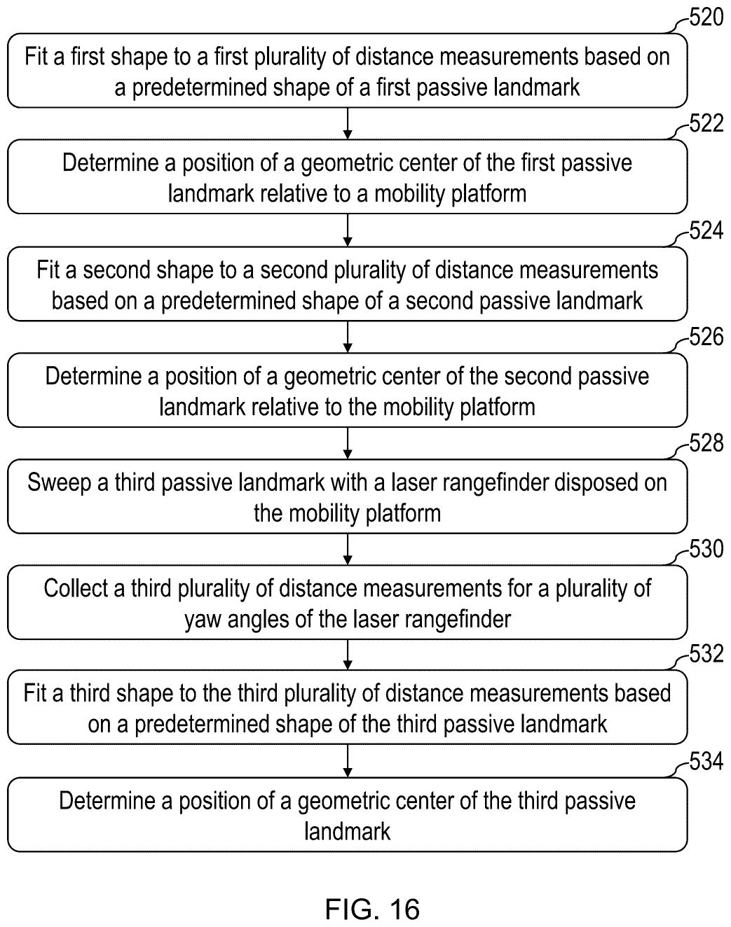

FIG. 16 is a block diagram for an exemplary embodiment of a method of operating a mobility platform. In block 520, a first shape is fit to a first plurality of distance measurements based on a predetermined shape of a first passive landmark. In some embodiments, the first plurality of distance measurements may be obtained according to process described with reference to FIG. 15. In block 522, a position of a geometric center of the first passive landmark is determined relative to a mobility platform, based on the fit of the first shape to the first plurality of distance measurements. The geometric center may be disposed in the two dimensional plane of the worksite. In block 524, a second shape is fit to a second plurality of distance measurements based on a predetermined shape of a second passive landmark. In some embodiments, the second plurality of distance measurements may be obtained according to process described with reference to FIG. 15. In other embodiments, the second plurality of distance measurements may be obtained by a sweep of a second laser rangefinder disposed on a mobility platform. In block 526, a position of a geometric center of the second passive landmark is determined relative to a mobility platform, based on the fit of the second shape to the second plurality of distance measurements. The geometric center of the second passive landmark may also be disposed in the two dimensional plane of the worksite. In some embodiments, the relative positions of the geometric centers of the first passive landmark and the second passive landmark to a first laser rangefinder and/or second laser rangefinder may be employed to localize the mobility platform in the worksite, for example, as discussed with reference to FIGS. 10-11.

According to the embodiment of FIG. 16, in block 528, a third passive landmark is swept with a laser rangefinder disposed on the mobility platform. In some embodiments, sweeping the third passive landmark may include rotating the laser rangefinder through a plurality of yaw angles over an angular range. In block 530, a plurality of distance measurements are collected for the plurality of yaw angles of the laser rangefinder during the sweep of block 528. In block 532, a third shape is fit to the third plurality of distance measurements based on a predetermined (e.g., known) shape of the third passive landmark As noted above, in some optional embodiments, the method may include determining an error of the fit of the third shape to the third plurality of distance measurements. If the error is above a predetermined non-zero threshold, the method may include returning to block 528 and performing another sweep of the third passive landmark to obtain a new third plurality of measured distances. Such an arrangement may ensure the fit of the shape to the distance measurements is of appropriate accuracy and precision for localizing a mobility platform and/or the third passive landmark. In optional block 534, a position of a geometric center of the third passive landmark relative to the laser rangefinder is determined. The geometric center may be a geometric center of the predetermined third shape fit to the third plurality of distance measurements. The geometric center of the third passive landmark may be with reference to the plane of the worksite. In some embodiments, the geometric center of the third passive landmark may be transmitted to a remote server, other may be otherwise used to update a worksite plan. In this manner, the mobility platform may be employed to add additional landmarks to a worksite plan.

FIG. 17 is a perspective view of an exemplary embodiment of a passive landmark 300. According to the embodiment of FIG. 17, the passive landmark 300 is a cylindrical landmark, which may be a circle or ellipse viewed in the worksite plan view (for example, see FIGS. 12A-12B). In other embodiments, a passive landmark may have any desired shape that may be detectable with a fit of that shape to measured distance data obtained by a sweep of the passive landmark by a laser rangefinder. For example, two dimensional shapes for a passive landmark in the plan view may include, but are not limited to, ellipses, circles, triangles, squares, rectangles, pentagons, hexagons, and octagons. According to the embodiment of FIG. 17, the passive landmark includes a central portion 302 configured for targeting and distance measurement by a phase shift laser rangefinder. In some embodiments, the central portion may be wrapped with reflective tape that returns higher intensity values when measured by the laser rangefinder. In some embodiments as shown in FIG. 17, the passive landmark includes two visual markers 304 disposed above and below the central portion 302. In some embodiments, the visual markers are formed of retro-reflective micro prismatic tape which allows high visibility and long-range detection of the targets at any time of the day in varying weather and light conditions for a camera. In some embodiments, the visual markers may be easily identifiable as bright portions when illuminated with infrared light (e.g., via an infrared light source) and imaged by a camera. A process of visual detection of the passive landmark of FIG. 17 will be discussed further with reference to FIGS. 18A-18C.

FIG. 18A is an example of an image of a passive landmark captured by a camera of a mobility platform. The image of FIG. 18A may be captured by the sensor system of FIGS. 7-9, in some embodiments. In some embodiments, an infrared light source may illuminate the worksite in a light beam angle. The camera may capture image information from the worksite in a field of view. Specifically, the camera may be configured to capture infrared light reflected from objects in the worksite that are illuminated by the infrared light source. As shown in FIG. 18A, a passive landmark is clearly visible with a middle portion 302 and the two visual markers 304. The visual markers 304, being reflective to infrared light, appear as bright white portions in the image and are distinctive from the rest of the image.

In some embodiments, the image of FIG. 18A may be a differential image created by combining two images. Specifically, in some embodiments, the camera may capture a first image while the passive landmark is illuminated with the infrared light source. The camera may also capture a second image while the passive landmark is not illuminated with the infrared light source (for example, when the infrared light source is turned off). In some embodiments, the second image may be subtracted from the first image, as content in the second image may not be relevant for landmark identification and may represent background illumination noise. At least one processor of a sensor system and/or mobility platform may be configured to control emission of infrared light from the infrared light source and the combination of multiple images to generate differential images that may be used for tracking passive landmarks. In some embodiments, the at least one processor may be configured to control the intensity of emitted infrared light based on a position of the mobility platform relative to a passive landmark. For example, the infrared light source may be controlled to reduce an intensity of infrared light emitted from the infrared light source as the distance to a passive landmark is reduced.

FIG. 18B is an example of the image of FIG. 18A processed to a binary image. In some embodiments as shown in FIG. 18B, a hue, saturation, and brightness value filter may be applied to the image of FIG. 18A by at least one processor of a sensor system and/or mobility platform. In some embodiments, a hue, saturation, and brightness value filter may establish thresholds for each of hue, saturation, and brightness, and compare each pixel in the image to the thresholds. Depending on the thresholds, the pixel may be assigned either 0 or 1 (e.g., gray or white, as depicted for clarity, though black and white may be employed in some embodiments). Such a process may filter partially reflective structures in the worksite that are not passive landmarks. However, the image information from the reflected light on the visual markers 304 of FIG. 18A exceeds the thresholds and appear as identified markers 306 in the processed image of FIG. 18B.

FIG. 18C is an example of the image of FIG. 18B with the passive landmark

identified by computer vision methods. In some embodiment, at least one processor of a sensor system and/or mobility platform may be configured to identify one or more bright regions in the binary image of FIG. 18B. In some embodiments, the at least one processor may also be configured to apply thresholds such as combining the top and bottom detections, checking the angle between both the detections and making sure the detections are within a predetermined tolerance threshold, and/or applying shape, size, height and width ratio thresholding to match to a target of specific size. Such thresholds may be calibrated assuming the size of the target will constantly change based on the mobility platform moving towards or away from the passive landmark, in some embodiments. In some embodiments, certain sections of the field of view of the camera may be removed to remove outliers or false detections. As shown in FIG. 18C, the at least one processor may draw a bounding box 308 around the detected target with a height and width. A label 309 may also be applied to the detected passive landmark in some embodiments.

In some embodiments, the detected passive target as shown in FIG. 18C may be employed to track the passive target with a laser rangefinder as the mobility platform moves through a worksite. For example, in some embodiments, the height and width of the bounding box 308 may be provided to at least one processor for feedback control of a yaw and/or pitch actuator of a sensor system (for example, see FIGS. 7-9). In some embodiments, a centroid tracking algorithm may be employed to ensure a laser rangefinder is oriented toward the detected passive landmark in real time.

In some cases there may be multiple passive landmarks in a field of view of the camera. In such cases and in some embodiments, the passive landmark closest to the center of the image in the field of view may be detected and tracked. In some embodiments, at least one processor may compare a location of the passive landmark with the expected location from a landmark database, which may help in reducing chances of detecting and pointing at a wrong passive landmark.

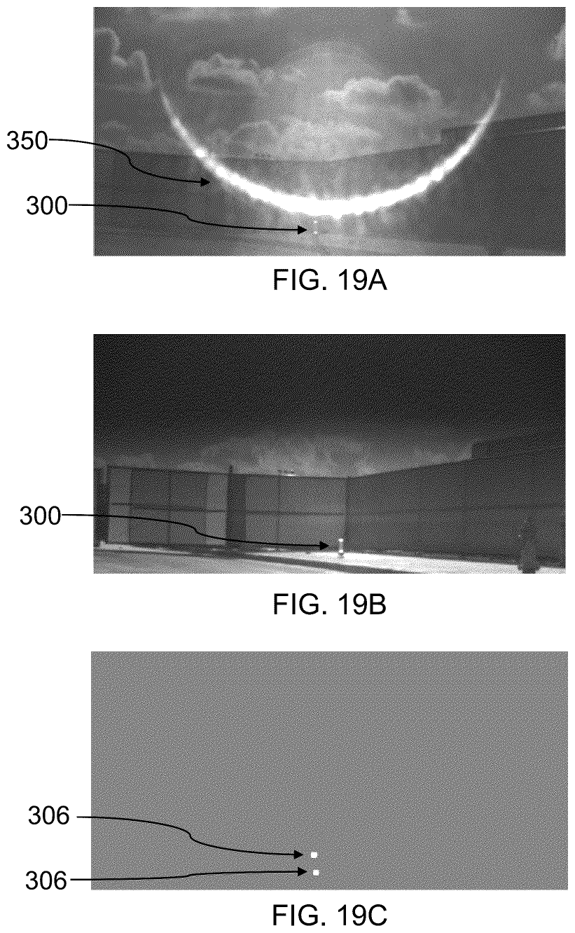

FIG. 19A is an example of an image of a passive landmark captured by a camera of a mobility platform. The image of FIG. 19A is representative of using a camera in an outdoor worksite illuminated by the sun. Glare 350 appears in the image, which may cause errors in detection of a passive landmark 300.

FIG. 19B is an example of the image of a passive landmark of FIG. 19A captured by the camera employing an embodiment of a hood, for example, as shown in FIGS. 7-9. The hood is configured to obstruct a portion of the field of view of the camera and block environmental light from refracting in the lens of the camera. Accordingly, as shown in FIG. 19B, the glare is eliminated and the passive landmark 300 clearly appears with two visual markers visible. FIG. 19C is an example of the image of FIG. 19B processed to a binary image using a hue, saturation, and brightness filter, resulting in two identified markers 306 in the binary image. The binary image may be employed to detect the passive landmark, as discussed with reference to FIGS. 18A-18C.

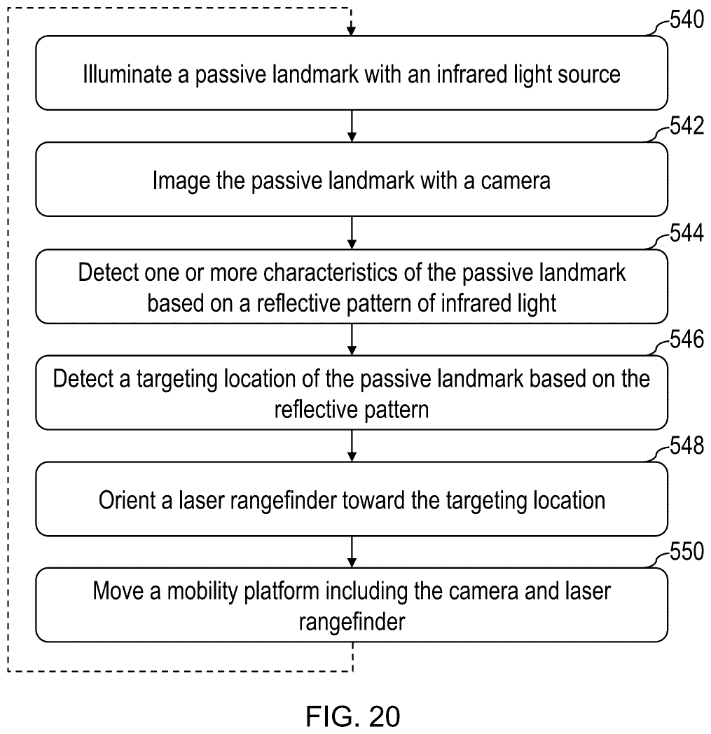

FIG. 20 is a block diagram for an exemplary embodiment of a method of operating a mobility platform. In block 540, a passive landmark is illuminated with an infrared light source. In some embodiments, the infrared light source may be disposed on a housing of a sensor system. The sensor system may also include a laser rangefinder and a camera disposed on the housing. The housing may be configured to be moved in one or more directions. For example, the housing may be rotated in the yaw direction or pitch direction to orient a light beam angle of the infrared light source toward passive landmarks the in worksite. One or more actuators may be employed to rotate the housing. In block 542, the passive landmark is imaged with the camera. In some embodiments, the camera may capture infrared light originating from the infrared light source that is reflected from the passive landmark. In some embodiments, the camera may include an infrared band pass filter positioned over the camera lens that is configured to allow only infrared light to be captured by the camera.

In block 544, one or more characteristics of the passive landmark may be detected based on the reflective pattern of infrared light. For example, a pattern may be detected (e.g., two rectangular bright portions separated by a particular angle). Characteristics may include, but are not limited to, brightness, size, pattern, spacing, etc. In block 546, a targeting location of the passive landmark is detected based on the reflective pattern. The targeting location may be an orientation of the housing resulting in the laser rangefinder axis being aligned to intersect the passive landmark. For example, one or more thresholds may be applied to the image information to detect the passive landmark within the image information. In block 548, the laser rangefinder may be oriented toward the targeting location. In block 550, the mobility platform may be moved, where the mobility platform includes the camera and laser rangefinder. The process of FIG. 20 may optionally repeat. In some cases, the process of FIG. 20 may occur in real time as a mobility platform moves, allowing for live tracking of a passive landmark using computer vision techniques to maintain distance measurements between the mobility platform and the passive landmark.

FIG. 21 is a top schematic view of an exemplary embodiment of a mobility platform 110 in a first position, a worksite, and a plurality of passive landmarks 300A, 300B. The mobility platform 110 includes a chassis 112. The mobility platform 110 also includes a drive system including four wheel assemblies 118A, 118B, 118C, 118D that are configured to move and orient the chassis 112 within the worksite. The drive system of the mobility platform of FIG. 21 may be holonomic and may operate like the drive system described with reference to FIGS. 2-4. The wheel assemblies underlying the chassis 112 are shown in dashed lines for clarity of the orientation of the wheel assemblies. The mobility platform also includes a first laser rangefinder 150A and a second laser rangefinder 150B mounted to the chassis 112. The first laser rangefinder 150A and the second laser rangefinder 150B are configured to measure distances to respective landmarks so that a position and orientation of the mobility platform within the worksite may be determined (e.g., a position and orientation within the xy plane). The mobility platform of FIG. 21 is configured to mark a floor of a worksite and includes a marking device 140.

As shown in FIG. 21, the worksite includes a first passive landmark 300A and a second passive landmark 300B. The first passive landmark 300A and the second passive landmark 300B may be placed on known landmark position points (e.g., control points) within the worksite. Accordingly, the passive landmarks may be used to determine an absolute position and orientation of the mobility platform using distance measurements by the first and second laser rangefinders, 150A, 150B. Such a process is discussed further above with reference to FIG. 10. In some embodiments, the mobility platform may also include at least one wheel odometer configured to provide odometry information used to determine a local position and orientation of the mobility platform. The local position may be verified against a position determined using the first laser rangefinder 150A and the second laser rangefinder 150B. Additional or alternative sensors may be employed in some embodiments, including and inertial measurement unit, as the present disclosure is not so limited. Additionally, in some embodiments the first and second laser rangefinders may be employed to localize the mobility platform as the mobility platform moves in real time.

As shown in FIG. 21, a plan for a layout is shown in the worksite in small, dashed lines. In particular, lines 400 indicate portions of the worksite to be marked with a marking fluid to form a visible line within the worksite. Additionally, the plan for markings in the worksite according to the embodiment of FIG. 21 includes text 402. The lines 400 and text 402 may be marked by positioning the marking device 140 over the region to be marked and commanding the marking device to deposit marking fluid in the desired locations according to the plan. A drive path for the mobility platform 110 may provide for changes in position and orientation to position the marking device 140 over all lines 400 and text 402 to be marked within the worksite. In some embodiments, the drive path may be generated according to task efficiency (e.g., the fastest way to mark all of the lines 400 and text 402 in the worksite). In some embodiments, a drive path may be generated at least in part based on progressive completion of a task field (e.g., working across a worksite), consistent readability of markings (e.g., orienting all text 402 in the same direction), and reducing motion between tasks to eliminate the need for reacquisition of the first landmark 300A and the second landmark 300B at various task locations.

FIG. 22 depicts the mobility platform 110 of FIG. 21 as it performs a task of marking a line 400 in the worksite. As shown in FIG. 22, as the marking device 140 is positioned over the planned line 400, a marking 404 may be made with marking fluid. As shown in FIG. 22, the mobility platform 110 may move along the planned line 400 to ensure the marking device 140 is able to make the marking 404. In some embodiments, the mobility platform 110 may move continuously over a length of a planned line 400. In some embodiments, before beginning to make a marking 404, the mobility platform may stop and verify its position using distance information from the first laser rangefinder 150A and the second laser rangefinder 150B. Additionally, in some embodiments the mobility platform may stop and verify its position at the end of marking a continuous line 400. In some embodiments, in between a start point and end point of a planned line 400, the mobility platform may move and make a marking 404 continuously. In some embodiments as discussed with reference to FIG. 15, the mobility platform may be able to mark continuous curved lines. In some embodiments, the mobility platform may stop at predetermined intervals in distance traveled or time to verify its position using distance measurements from the first laser rangefinder and the second laser rangefinder. During the verification of its position using the first laser rangefinder and second laser rangefinder, the laser rangefinders may perform a sweep with shape recognition of passive landmarks, as discussed above. As shown in FIG. 22, as the mobility platform moves, the wheel assemblies 118A, 118B, 118C, 118D may change in orientation to allow the position of the mobility platform to change without changing its orientation. In some embodiments, both a position and orientation of the mobility platform may change as the mobility platform moves through a drive path. As shown in FIG. 22 compared with FIG. 21, a yaw angle of the first laser rangefinder 150A and the second laser rangefinder 150B may change to track the first passive landmark 300A and the second passive landmark 300B. The change in yaw angle of the first laser rangefinder and the second laser rangefinder may be based on information from one or more other sensors, such as a camera as discussed with reference to FIGS. 18A-20.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively, or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

### Positioning Device

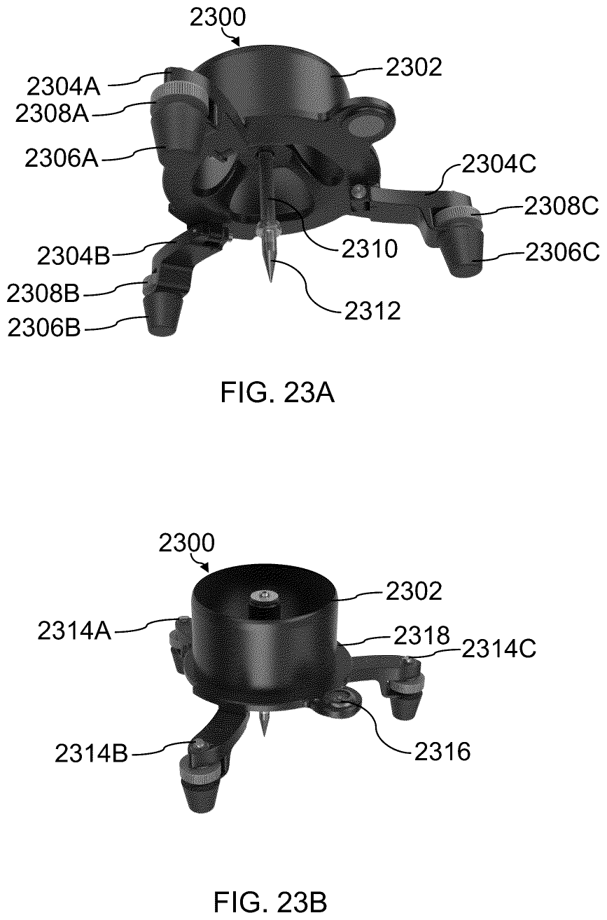

FIG. 23A is a perspective view of a positioning device, according to some embodiments. The positioning device includes a base 2300 and three legs 2304A, 2304B, 2304C that extend radially from the base. Each of the three legs 2304A, 2304B, 2304C is hingedly connected to the base 2300. The legs 2304A, 2304B, 2304C have respective feet 2306A, 2306B, 2306C that contact a surface when the positioning device is placed on the surface. The legs 2304A, 2304B, 2304C extend radially to form a tripod that keeps the positioning device stable. The legs 2304A, 2304B, 2304C provide stability to prevent the positioning device (and a target placed thereon) from moving as a result of external force (e.g., wind, vibration, and/or other forces). In some embodiments, the feet 2304A, 2304B, 2304C may be made of material that dampens vibrations. For example, the feet 2304A, 2304B, 2304C may be a rubber material such as neoprene, natural rubber, or ethylene propylene diene monomer (EPDM) rubber.

In some embodiments, each of the feet 2306A, 2306B, 2306C may have an adjustable position relative to its respective leg. The position may be adjustable independently of the other feet. The adjustable position of the feet 2306A, 2306B, 2306C relative to respective legs 2304A, 2304B, 2304C allows for pitch and roll rotational alignment of the positioning device. When a surface on which the positioning device is placed is not level, the position of the feet relative to the legs may be adjusted such that the base 2300 is level. Each of the legs 2304A, 2304B, 2304C may have a mechanism to adjust the relative position of its respective foot. In the example of FIG. 23A, the legs 2304A, 2304B, 2304C have respective thumb screws 2308A, 2308B, 2308C that may be used to adjust the position of respective feet 2306A, 2306B, 2306C relative to their respective legs 2304A, 2304B, 2304C. A thumb screw may be rotated in a first direction (e.g., clockwise) to decrease the distance of a foot from its respective leg and in a second direction (e.g., counterclockwise) to increase the distance of the foot from its respective leg. The thumb screws 2308A, 2308B, 2308C allow adjustment of the feet's position without the use of a tool. This allows for efficient adjustment of a positioning device (e.g., pitch and/or roll adjustments) when placing it at a worksite. For example, different feet may need to be at different positions relative to their legs to account for variations in the height of the surface on which the positioning device is placed. The position of each foot may be adjusted to stabilize the landmark at a location (e.g., by making sure that the base 2300 is level).

Each of the thumb screws 2308A, 2308B, 2308C may control the position of a respective shaft connecting a respective foot to its leg. FIG. 23B is another view of the positioning device of FIG. 23A. FIG. 23B shows shafts 2314A, 2314B, 2314C inserted through respective legs 2304A, 2304B, 2304C. Each of the shafts 2314A, 2314B, 2314C connects a leg to its foot and thumb screw. The thumb screw may be rotated to adjust the position of the shaft thereby adjusting the position of the foot relative to the leg. In some embodiments, the position of the shaft may indicate the position of the foot relative to the leg. For example, when the shaft is co-planar with the top surface of the leg, the foot may be at a mid-point of its positional range. FIG. 23B further shows a bubble level 2316 indicating whether the base 2300 is level. The bubble level 2316 may be used to ensure that a landmark is stably placed at a location.

As shown in FIG. 23A, the positioning device includes a rod 2310 with an alignment spike 2312 attached to its end. The alignment spike 2312 may be used for translational alignment of the positioning device with a point on a surface of a worksite. When the positioning device is deployed on a surface, the alignment spike 2312 may contact a point on the surface. In some embodiments, the alignment spike 2312 may have a passive vertical degree of freedom to maintain contact with the surface during height adjustment of the base 2300 (e.g., that results from adjusting heights of one or more of the feet 2306A, 2306B, 2306C). The rod 2310 may be configured to slide along a longitudinal axis of the cylindrical base 2310. When the positioning device is placed on a surface, the rod 2310 may slide towards the surface due to gravitational force such that the alignment spike 2312 contacts a point on the surface. The gravitational force may maintain contact between the alignment spike 2312 and the point on the surface to allow for accurate placement.

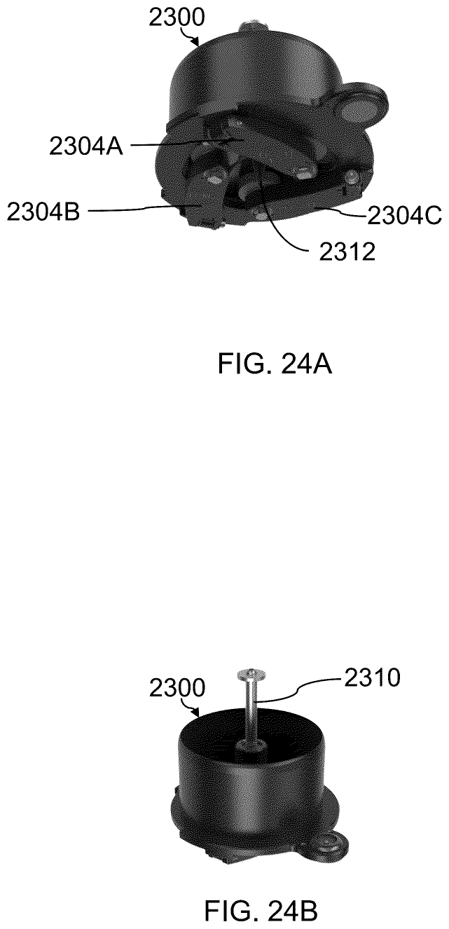

In some embodiments, the legs 2304A, 2304B, 2304C of base 2300 shown in FIGS. 23A-23B may be configurable to fold into the base 2300. FIG. 24 shows a base 2300 in a stowed configuration where the legs 2304A, 2304B, 2304C are folded into a recessed portion of the base 2300. Each of the legs 2304A, 2304B, 2304C may be rotated around a connection point with the base 2300 into a folded position (also referred to as a “stowed position”). For example, the connection point may be a joint or hinge that rotates to allow the leg to fold into a stowed position or out into an extended position. The base 2300 is recessed such that the feet 2306A, 2306B, 2306C of the legs 2304A, 2304B, 2304C are tucked into the recessed portion of the base 2300 when the legs 2304A, 2304B, 2304C are folded in the stowed position. In some embodiments, the legs 2304A, 2304B, 2304C may be rotated into an extended position and a stowed position. In some embodiments, the legs 2304A, 2304B, 2304C may additionally be rotated into one or more intermediate positions between an extended position and the stowed position. For example, the legs 2304A, 2304B, 2304C may be rotated into intermediate position(s) based on a surface on which the positioning device is placed (e.g., to make the base 2300 level).

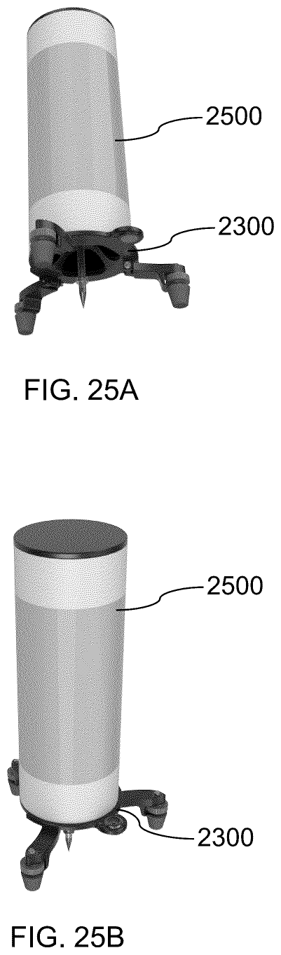

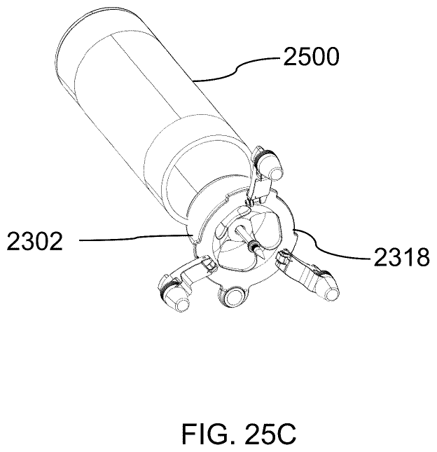

As shown in the example of FIGS. 23A-23B, the base 2300 includes a central portion 2302 attached to a flange 2318. As discussed herein with reference to FIGS. 25A-25C, the central portion 2302 may engage with a target placed on the base 2300. In the example of FIGS. 23A-23B, the central portion 2302 is cylindrical. The target may, for example, be a cylindrical target, a portion of which is placed around the central portion 2302 and rests on the flange 2318. The central portion 2302 may encompassed by a portion of the cylindrical target. For example, the cylindrical target may have a hollow body and the central portion 2302 may be inserted into a portion of the hollow body.

Although the base 2300 in the example of FIG. 23A is cylindrical, in some embodiments, the base 2300 may be a different shape. For example, in some embodiments, the base of the positioning device may be a prism or other suitable shape. Likewise, the central portion 2302 may be a different shape. For example, in some embodiments, the central portion 2302 of the base may be a prism or another suitable shape

FIG. 24A shows the positioning device of FIGS. 23A-23B in a stowed position, according to some embodiments. In some embodiments, the rod 2310 and attached alignment spike 2312 may slide into the body of the base 2300. The rod 2310 may lock into a stowed position in which the rod 2310 and alignment spike 2312 are within the body of the base 2300 as shown in FIG. 24A. The rod 2310 may have a locking mechanism that holds the rod 2310 in the stowed position and prevents it from sliding out from the bottom of the base 2300. In some embodiments, the rod and the base include threads such that the rod may be screwed into the base. For example, so a 180 degree rotation of the rod in a particular rotational direction (e.g., clockwise) may screw the into the base such that the threads of the rod and base prevent the rod from sliding out of the base. It is capped on the other end to not fall entirely out of the base along the linear bearing. FIG. 24B shows another view of the positioning device in the stowed position. FIG. 24B shows the rod 2310 in its stowed position such that the alignment spike 2312 is within the base 2300.

FIG. 25A is a perspective view of the positioning device of FIGS. 23A-23B engaged with a target. FIG. 25B is another view of the positioning device engaged with the target. The positioning device is in a configuration with its legs fully extended radially from the body of the base 2300 to provide support. The base 2300 includes a portion that engages with the target 2500. This portion may also be referred to as a “target engagement portion”. In the example of FIGS. 25A-25B, the portion is a cylindrical portion of the base 2300 with a diameter smaller than that of a cylindrical target. The target 2500 is a cylindrical body placed over the target engagement portion of the base 2300. The base 2300 includes a flange beneath the target engagement portion. The flange has a larger diameter than the target 2500 such that the target 2500 rests on the flange when placed on the base 2300. The target 2500 may be used to perform measurements by a measurement platform (e.g., a mobility platform or a stationary platform). Techniques of using the target 2500 to perform measurements are described herein. For example, the target 2500 may be detected by a mobility platform using a laser rangefinder to collect distance measurements.

FIG. 25C is an exploded view illustrating how the target 2500 engages with the poisoning device. As shown in FIG. 25C, the portion 2302 of the base 2300 is inserted into the target 2500. The target 2500 surrounds the portion 2302 of the base 2300. The target 2500 rests on the flange 2318 of the base 2300 when the positioning device is placed on a surface. Although in the example of FIG. 25C, the target 2500 and portion 2302 of the base 2300 are cylindrical, in some embodiments, the target 2500 and portion 2302 may be a different shape. For example, the target may be a prism. In some embodiments, the target 2500 may have a reflective surface. For example, the target may be a reflective prism (e.g., a triangular glass prism).

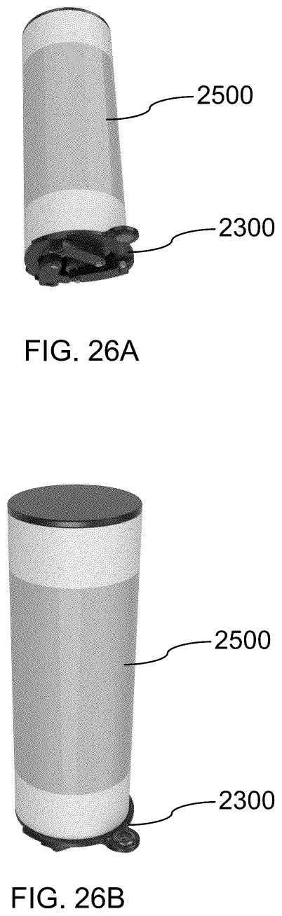

FIG. 26A is a perspective view of a positioning device in a stowed configuration with the target 2500 engaged with the base 2300. FIG. 26B is another view of the positioning device of FIG. 26A. The target 2500 may be placed on the base 2300 in the stowed configuration. For example, the legs 2304A, 2304B, 2304C may not be needed for support. The target 2500 may be placed on the base 2300 while it is in the stowed configuration with the legs 2304A, 2304B, 2304C folded into a recessed portion of the base 2300 (e.g., so that the landmark takes up less space than if the legs 2304A, 2304B, 2304C were extended). In other cases (not illustrated in FIGS. 26A-26B), one or more of the legs 2304A, 2304B, 2304C may be partially or fully extended from the base 2300.

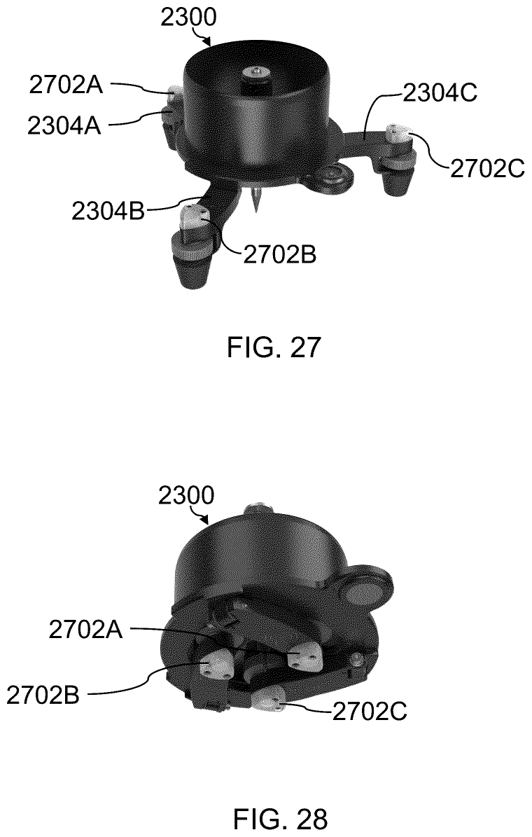

FIG. 27 is a perspective view of a positioning device with caps placed on its legs. The caps 2702A, 2702B, 2702C are placed on top of the legs 2304A, 2304B, 2304C of the base 2300. The caps 2702A, 2702B, 2702C may be placed over shafts of their respective legs 2304A, 2304B, 2304C to protect the shafts. For example, the caps 2702A, 2702B, 2702C may be dust caps that prevent the collection of dust on or around the shafts. FIG. 28 shows the positioning device in a stowed position with the caps 2702A, 2702B, 2702C. In the stowed configuration, the caps 2702A, 2702B, 2702C remain beneath the bottom surface of the base 2300.

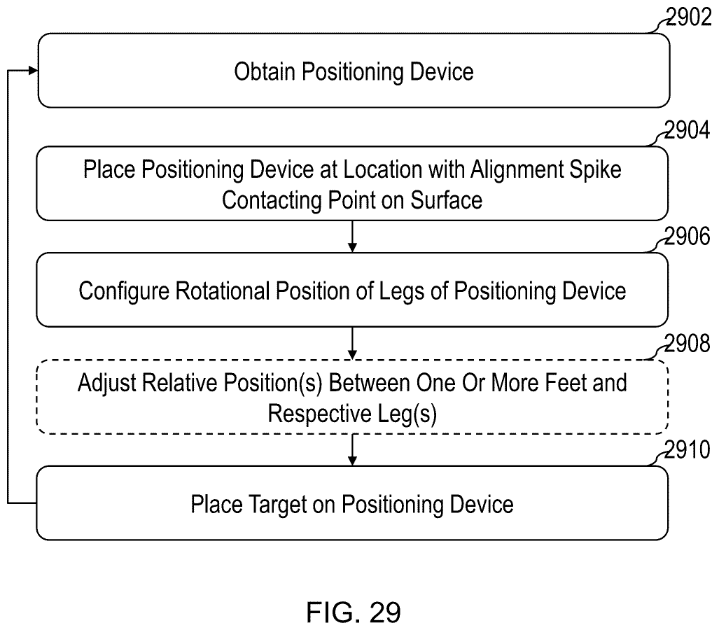

FIG. 29 is a flowchart of an example method for placing targets in an environment using positioning devices, according to some embodiments of the technology described herein. The method of FIG. 29 may be performed to place targets in an environment to allow an autonomous system to navigate around the environment. For example, the method of FIG. 29 may be performed to place passive landmarks around a worksite for use by a mobility platform in navigation (e.g., by performing measurements using the passive landmarks). As another example, the method of FIG. 29 may be performed to place passive landmarks around a worksite for use by a surveyor in determining the position of a total station.

The method begins at block 2902 by obtaining a positioning device. The positioning device may be a positioning device described herein with reference to FIGS. 23A-28. In some embodiments, the positioning device may be manually obtained (e.g., picked up by a user to be placed). In some embodiments, the positioning device may be obtained by an autonomous system.

Next, at block 2904, the method comprises placing the positioning device at location with an alignment spike contacting a point on a surface on which the positioning device is placed. The alignment spike may move along a longitudinal axis of the positioning device (e.g., by gravitational force and/or another force) until the alignment spike contacts the point (e.g., a control point of a worksite). In some embodiments, the positioning device may be adjusted on the surface to align the alignment spike with the point. For example, the positioning device may be used in a two-dimensional plane until the alignment spike aligns with the point (e.g., marked on the surface).

Next, at block 2906, the method comprises adjusting a rotational position of the positioning device's legs. In some cases, one or more of the legs may be rotated to a fully extended position (e.g., as illustrated in FIGS. 23A-23B). In some cases, one or more of the legs may be configured in a stowed position (e.g., folded in to a recess of the base as shown in FIG. 24A-FIG. 24B). For example, the legs may be stowed if a tripod support is not needed to stabilize the positioning device. In some cases, one or more of the legs may be partially extended. The leg(s) may be rotated around a joint or hinge that is mounted to the base.

Next, at block 2908, the method comprises adjusting relative position(s) between one or more feet and their respective leg(s). This step may be optionally performed if the relative position(s) need to be adjusted. For example, the relative position(s) may be adjusted to account for a grade in the surface to ensure that the base of the positioning device is level. In some embodiments, the relative position(s) may be adjusted by thumb screw(s) that, when rotated, adjust the relative position(s) of the one or more feet relative to their respective leg(s) (e.g., by increasing or decreasing the distance(s) between the one or more feet and their respective leg(s)).

Next, at block 2910, the method comprises placing a target on the positioning device. The target may be engaged with a portion of the base of the positioning device. For example, the target may be a cylindrical target that is placed on a filange of the base such that a central cylindrical portion of the positioning device's base is inserted into the target (e.g., as illustrated in FIG. 25C).

After placement of the target, the method may return to block 2902 where another positioning device is obtained and the steps of blocks 2904-2910 are repeated to place another target (e.g., another passive landmark) at a respective location (e.g., at another point in a worksite). Blocks 2902-2910 may be repeated until all the targets are placed in the environment. For example, the method may be complete when all the passive landmarks are placed at respective positions in a worksite using respective positioning devices.

### Example Embodiments

Some embodiments provide a positioning device for positioning a target in an environment for use by a system for localization in the environment, the positioning device including: a base; a rod extending along a longitudinal axis of the base; an alignment spike attached to a first end of the rod, the alignment spike including a tip for contacting a point on a surface that the positioning device is placed upon; and at least three legs hingedly connected to the base, each of the at least three legs configured to: extend radially from the base; and retract radially towards the base.

In some embodiments, the rod has a passive vertical degree of freedom along the longitudinal axis of the base. In some embodiments, the base is cylindrical.

In some embodiments, the target is a prism.

In some embodiments, each of the at least three legs includes a foot, the foot having a position relative to the leg that is adjustable. In some embodiments, the position of the foot relative to the leg is adjustable independently of positions of other feet relative to other legs. In some embodiments, feet of the at least three legs are rubber feet.

In some embodiments, each of the at least three legs includes a screw that, when rotated, modifies a position between the leg and the leg's foot. In some embodiments, the screw is a thumb screw. In some embodiments, the at least three legs consist of three legs equally spaced along a radial axis around the base.

In some embodiments, the positioning device has: a stowed position in which the at least three legs are folded into the base; a partially extended position in which the at least three legs are partially extended radially from the base; and a fully extended position in which the at least three legs are fully extended radially from the base.

In some embodiments, the rod and the base each include threads, and the rod is configured to screw into the base.

In some embodiments, the positioning device further includes a bubble level indicating whether the base is level.

In some embodiments, the base is a cylindrical base with a maximum diameter between approximately 1 in and 6 inches with the at least three legs retracted.

In some embodiments, the positioning device further includes a target supported by the base.

In some embodiments, the target is a cylindrical target with a diameter of less than 5 inches. In some embodiments, the base includes: a flange; and a central portion connected to the flange, the central portion engaged with the target. In some embodiments, the target is a cylindrical target, the central portion of the base is cylindrical, and at least a portion of the cylindrical target surrounds the central portion. In some embodiments, the target includes a reflective coating on a surface of the target.

In some embodiments, the positioning device with the target placed thereon has a weight of less than 50 oz.

Some embodiments provide a system for navigation of a mobility platform in a worksite, the system including: a plurality of passive landmarks placed at a plurality of locations in the worksite for use by the mobility platform in navigating throughout the worksite, each of at least some of the plurality of passive landmarks placed using a positioning device including: a base; a rod extending along a longitudinal axis of the base; an alignment spike attached to a first end of the rod, the alignment spike including a tip for contacting a point on a surface that the positioning device is placed upon; and at least three legs hingedly connected to the base, each of the at least three legs configured to: extend radially from the base; and retract radially towards the base.

In some embodiments, the system further includes the mobility platform, wherein the mobility platform is configured to use the plurality of passive landmarks to navigate around the worksite. In some embodiments, the mobility platform includes a laser rangefinder configured to measure a point distance to each of at least some of the plurality of passive landmarks positioned at the plurality of locations in the worksite.

Some embodiments provide a positioning device for positioning a target in an environment for use in locating a system in the environment, the positioning device including: a base including a target engagement portion; a rod extending along a longitudinal axis of the base; an alignment spike attached to a first end of the rod, the alignment spike including a tip for contacting a point on a surface that the positioning device is placed upon; and at least three legs each hingedly attached to the base, the at least three legs extended radially from the base.

Some embodiments provide a positioning device for positioning a target in an environment for use in locating a system in the environment, the positioning device including: a base including: a target engagement portion; and a recessed portion; a rod extending along a longitudinal axis of the base; an alignment spike attached to a first end of the rod, the alignment spike including a tip for contacting a point on a surface that the positioning device is placed upon; and at least three legs hingedly mounted to an under surface of the base, the at least three legs fully stowed in the recessed portion of the base.

Some embodiments provide a positioning device for positioning a target in an environment for use in locating a system in the environment, the positioning device including: a cylindrical base, the cylindrical base including: a flange; and a central portion attached to the flang; a rod extending along a longitudinal axis of the base; an alignment spike attached to a first end of the rod, the alignment spike including a tip for contacting a point on a surface that the positioning device is placed upon; and at least three legs hingedly mounted to the flange of the cylindrical base.

Some embodiments provide a method of placing a plurality of landmarks in a worksite for use in locating a system in the worksite, the method including: for each of a plurality of positioning devices, placing the positioning device at a location in the worksite with an alignment spike of the positioning device contacting a point on a surface on which the positioning device is placed; configuring a rotational position of one or more retractable legs of the positioning device; placing a landmark on the positioning device.

In some embodiments, In some aspects, the techniques described herein relate to a method, wherein configuring the rotational position of the one or more retractable legs of the positioning device includes extending the one or more retractable legs from a base of the positioning device.

In some embodiments, configuring the rotational position of the one or more retractable legs of the positioning device includes configuring the one or more retractable legs into a folded position in which the one or more retractable legs are folded into a recess of a base of the positioning device.

In some embodiments, the method further includes: for a first one of the plurality of positioning devices, adjusting a position of a foot of the first positioning device relative to a respective leg of the first positioning device. In some embodiments, adjusting the position of the foot relative to the respective leg includes using a thumbscrew to adjust the position of the foot relative to the respective leg.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A positioning device for positioning a target in an environment for use by a system for localization in the environment, the positioning device comprising:
a base;
a rod extending along a longitudinal axis of the base;
an alignment spike attached to a first end of the rod, the alignment spike comprising a tip for contacting a point on a surface that the positioning device is placed upon; and
at least three legs hingedly connected to the base, each of the at least three legs configured to:
extend radially from the base; and
retract radially towards the base.

2. The positioning device of claim 1, wherein the rod has a passive vertical degree of freedom along the longitudinal axis of the base.

3. The positioning device of claim 1, wherein the base is cylindrical.

4. The positioning device of claim 1, wherein the target is a prism.

5. The positioning device of claim 1, wherein each of the at least three legs comprises a foot, the foot having a position relative to the leg that is adjustable.

6. The positioning device of claim 5, wherein the position of the foot relative to the leg is adjustable independently of positions of other feet relative to other legs.

7. The positioning device of claim 5, wherein feet of the at least three legs are rubber feet.

8. The positioning device of claim 5, wherein each of the at least three legs comprises a screw that, when rotated, modifies a position between the leg and the leg's foot.

9. The positioning device of claim 8, wherein the screw is a thumb screw.

10. The positioning device of claim 1, wherein the positioning device has:
a stowed position in which the at least three legs are folded into the base;
a partially extended position in which the at least three legs are partially extended radially from the base; and
a fully extended position in which the at least three legs are fully extended radially from the base.

11. The positioning device of claim 1, wherein the rod and the base each comprise threads, and the rod is configured to screw into the base.

12. The positioning device of claim 1, further comprising a bubble level indicating whether the base is level.

13. The positioning device of claim 1, wherein the base is a cylindrical base with a maximum diameter between approximately 1 in and 6 inches with the at least three legs retracted.

14. The positioning device of claim 1, further comprising a target supported by the base.

15. The positioning device of claim 14, wherein the target is a cylindrical target with a diameter of less than 5 inches.

16. The positioning device of claim 14, wherein the base comprises:
a flange; and
a central portion connected to the flange, the central portion engaged with the target.

17. The positioning device of claim 14, wherein the target comprises a reflective coating on a surface of the target.

18. The positioning device of claim 1, wherein the positioning device with the target placed thereon has a weight of less than 50 oz.

19. A system for navigation of a mobility platform in a worksite, the system comprising:
a plurality of passive landmarks placed at a plurality of locations in the worksite for use by the mobility platform in navigating throughout the worksite, each of at least some of the plurality of passive landmarks placed using a positioning device comprising:
a base;
a rod extending along a longitudinal axis of the base;
an alignment spike attached to a first end of the rod, the alignment spike comprising a tip for contacting a point on a surface that the positioning device is placed upon; and
at least three legs hingedly connected to the base, each of the at least three legs configured to:
extend radially from the base; and
retract radially towards the base.

20. A method of placing a plurality of landmarks in a worksite for use in locating a system in the worksite, the method comprising:
for each of a plurality of positioning devices,
placing the positioning device at a location in the worksite with an alignment spike of the positioning device contacting a point on a surface on which the positioning device is placed;
configuring a rotational position of one or more retractable legs of the positioning device;
placing a landmark on the positioning device.
